(19) United States
(12) Patent Application Publication
(10) Pub. No.: US 2009/0239051 A1
(43) Pub. Date: Sep. 24, 2009

(54) HYDROPHILIC COMPOSITION AND HYDROPHILIC TREATED MEMBER

(76) Inventors: Makoto FUKUDA, Kanagawa (JP); Koh Kamada, Kanagawa (JP)

Correspondence Address: BIRCH STEWART KOLASCH & BIRCH, PO BOX 747, FALLS CHURCH, VA, 22040-0747, US

(21) Appl. No.: 12/408,166

(22) Filed: Mar. 20, 2009

(30) Foreign Application Priority Data
Mar. 21, 2008 (JP) P2008-074727

(51) Int. Cl. B32B 27/34; C08L 77/00; C08L 29/04

(52) U.S. Cl. 428/220; 524/608; 524/557

(57) ABSTRACT

A hydrophilic composition is provided the hydrophilic composition containing a hydrophilic polymer (A) containing a crosslinking group; and a W/O/W type emulsion (B).

### BACKGROUND OF THE INVENTION

1. Field of the Invention

The present invention relates to a hydrophilic composition useful for forming a hydrophilic film having antifouling property, antifogging property, higher scratch resistance and higher water-rubbing resistance on a surface of various substrates, and a hydrophilic treated member having an antifouling antifogging surface provided with a hydrophilic film formed of the hydrophilic composition.

2. Description of the Related Art

Conventionally, coating finish is performed for the frame protection, ornamentation or aesthetic enhancement of a building, a civil engineering structure, an automobile or the like. In particular, with the recent advent of a high-durability coating material such as fluororesin coating material, acrylic silicon resin coating material and polyurethane resin coating material, the performance in terms of frame protection has made a great progress. However, because of the innate characteristics of the resin, the surface of a coating film formed of such a high-durability coating material is generally hydrophobic or lipophilic. Accordingly, oil or the like when attached as a contaminant to the surface cannot be easily removed or due to its accumulation, the function or property of the product or member having this surface sometimes seriously deteriorates. In the case where a product or member having a transparency function is exposed to high-humidity conditions or rainfall, attachment of a water drop to a product or member brings about a problem that the transmission of light is inhibited by the diffused reflection of light. In the case of a product or member having an inorganic surface such as glass or metal, the antifouling property against attachment of a contaminant such as oil is low and the antifogging property against attachment of a water drop is also low. Above all, the glass for automobiles or buildings is often subjected to attachment of an urban soot or dust, a combustion product such as carbon black contained in the exhaust gas of an automobile or the like, or a hydrophobic contaminant such as oil/fat and component dissolved out from a sealant, or subjected to attachment of a water drop, making it difficult to ensure visibility through the glass (in the case of a mirror, by reflection), and it is strongly demanded to impart an antifouling or antifogging function.

In view of the antifouling property, envisaging that the contaminant is an organic substance such as oil, it is necessary for preventing the contamination to reduce the interaction with the material surface, that is, impart hydrophilicity or oil repellency. Also, in view of the antifogging property, it is necessary to impart extensive wettability of evenly spreading the attached water drop on the surface (that is, hydrophilicity) or impart water repellency that facilitates the removal of attached water drop. For these reasons, many of antifouling or antifogging materials which are being studied at present rely on the technique of imparting hydrophilicity or water/oil repellency.

According to the conventionally proposed surface treatment method for imparting hydrophilicity, such as etching treatment or plasma treatment, the surface is hydrophilized to a high level, but this effect is temporary and the hydrophilized state cannot be maintained for a long time. A surface hydrophilic coating film using a hydrophilic graft polymer is also proposed as one of hydrophilic resins (see, Newspaper, The Chemical Daily, article dated Jan. 30, 1995). This paper reports that the coating film has hydrophilicity to a certain extent, but the affinity for the substrate is insufficient and higher durability is demanded.

As for other members having a surface hydrophilic function, use of titanium oxide as a photocatalyst is conventionally known. This technique is based on the oxidative decomposition function and hydrophiling function of an organic material, which are exerted upon irradiation of light. For example, International Publication No. 96/29375, pamphlet discloses that when a photocatalyst-containing layer is formed on the surface of a substrate, the surface is hydrophilized to a high level according to the photoexcitation of the photocatalyst, and it is reported that when this technique is applied to various composites such as glass, lens, mirror, armoring material and water supply-related member, an excellent antifogging or antifouling function or the like can be imparted to the composite. A member obtained by coating titanium oxide on the glass surface is used as a self-cleaning material on the architectural window glass or vehicle front glass but must be exposed to sunlight for a long time so as to exert the antifouling or antifogging function, and its property is inevitably deteriorated due to contamination accumulated with long-term aging. Furthermore, the film strength is low and enhancement of durability is necessary. Also, a self-cleaning film obtained by providing a titanium oxide layer on a plastic substrate is being used for a vehicle side mirror or the like but fails in having a high film strength, and a hydrophilic material having higher abrasion resistance is demanded.

As regards the antifouling or antifogging material based on water repellency or oil repellency, a silicone compound or a fluorine compound is mainly used. For example, there are disclosed an antifouling material obtained by coating a silanol-terminated organopolysiloxane on the substrate surface in JP-A-4-338901 (the term “JP-A” as used herein means an “unexamined published Japanese patent application”), a material containing a silane compound having a polyfluoroalkyl group in JP-B-6-29332 (the term “JP-B” as used herein means an “examined Japanese patent publication”), and a combination of an optical thin film mainly containing silicon dioxide with a copolymer of a perfluoroacrylate and an alkoxysilane group-containing monomer in JP-A-7-16940. However, these antifouling materials using a silicone compound or a fluorine compound are low in the antifouling property, and contamination such as fingerprint, grease, sweat and cosmetic can be hardly removed. Moreover, the surface treatment with a compound having a low surface energy, such as fluorine and silicone, may cause reduction in the function with aging, and it is demanded to develop an antifouling or antifogging member having excellent durability.

On the other hand, JP-A-7-11152 proposes, for example, a curable composition containing a silyl group-containing emulsion, water-soluble resin, an epoxy group-containing compound or an organic aluminum compound. However, the coating film obtained from such a curable composition cannot have a high hydrophilic surface and is poor in the water resistance, contamination resistance and weather resistance. More improvements are demanded.

In order to solve these problems, when a vinyl-based copolymer having a hydrophilic group and a hydrolyzable silyl group is used for the coating material to enhance the surface hydrophilicity, the film quality becomes very brittle due to formation of a hydrogen bond by the hydrophilic group, and the scratch resistance decreases. Also, there is a problem that the inside of the film is hydrophilic and readily swells and the water-rubbing resistance is thereby reduced.

For improving the brittleness or suppressing the swelling, addition of a hydrophobic particle such as latex may be generally considered. However, when such a particle is added, the hydrophobic part comes out to the surface due to abrasion. A technique of hybridizing an inorganic component for suppressing the swelling is also studied (see, JP-A-2002-361800). According to this technique, the swelling may be suppressed but the film quality becomes brittle. Because of these problems, a hydrophilic material satisfying all of surface hydrophilicity, flexibility and suppression of swelling is not yet known.

On the other hand, a technique of adding a capsule enclosing a hydrophilic compound in a binder is also studied (JP-A-2007-246818). However, the hydrophilicity is brought out by allowing the binder to dissolve out into the solvent and causing the capsule to come out to the coating film surface and release the hydrophilic compound and therefore, when the hydrophilic compound is used up, hydrophilicity cannot be sustained. Also, the scratch resistance and water-rubbing resistance are poor due to low film strength and brittle property.

### SUMMARY OF THE INVENTION

Under these circumstances, the present invention has been made, and an object of the present invention is to enhance the dry scratch resistance by making the film quality flexible and dispersing the stress, enhance the wet scratch resistance by suppressing swelling in the inside of the film, and maintain the antifouling/antifogging property over a long period of time.

That is, the present invention is as follows:

(1) A hydrophilic composition, containing:

a hydrophilic polymer (A) containing a crosslinking group; and

a W/O/W type emulsion (B).

(2) The hydrophilic composition according to item (1),

wherein the W/O/W type emulsion (B) contains an inner aqueous phase, an outer aqueous phase and a wall material located between the inner aqueous phase and the outer aqueous phase.

(3) The hydrophilic composition according to items (1) or (2),

wherein the crosslinking group of the hydrophilic polymer (A) is a hydrolyzable silyl group.

(4) The hydrophilic composition according to item (3),

wherein the hydrophilic polymer (A) has a structure represented by following formula (I):

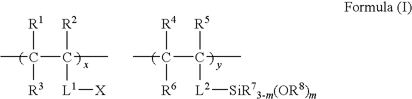

wherein R¹ to R⁸ each independently represents a hydrogen atom or a hydrocarbon group;

L¹ represents a single bond or a polyvalent organic linking group;

L² represents a single bond or a polyvalent organic linking group having at least one structure selected from the group consisting of —CONH—, —NHCONH—, —OCONH—, —SO₂NH— and —SO₃—;

m represents an integer of 1 to 3;

x and y define compositional ratio and each represents a number satisfying x+y=100 in ranges of 0<x<100 and 0<y<100; and

X represents —OH, —ORₐ, —CORₐ, —CO₂R_{c}, —CON(Rₐ)(R_{b}), —N(Rₐ)(R_{b}), —NHCOR_{d}, —NHCO₂Rₐ, —OCON(Rₐ)(R_{b}), —NHCON(Rₐ)(R_{b}), —SO₃Rₑ, —OSO₃Rₑ, —SO₂R_{d}, —NHSO₂R_{d}, —SO₂N(Rₐ)(R_{b}), —N(Rₐ)(R_{b})(R_{c}), —N(Rₐ)(R_{b})(R_{c})(R_{g}), —PO₃(Rₑ)(R_{f}), —OPO₃(Rₑ)(R_{f}) or —PO₃R_{d})(Rₑ) in which Rₐ, R_{b} and R_{c} each independently represents a hydrogen atom or an alkyl group, R_{d} represents an alkyl group, Rₑ and R_{f} each independently represents a hydrogen atom, an alkyl group, an alkali metal, an alkaline earth metal or an onium, and R_{g} represents an alkyl group, a halogen atom, an inorganic anion or an organic anion.

(5) The hydrophilic composition according to any of items (2) to (4),

wherein the wall material contains at least one selected from the group consisting of polyester resin, polyamide resin, acrylic resin, vinyl resin, hydrocarbon resin, epoxy resin, urethane resin, urea resin, acrylic silicon resin and polyamide resin.

(6) The hydrophilic composition according to any of items (2) to (5),

wherein a surface of the wall material is treated with a hydrophilic compound.

(7) The hydrophilic composition according to any of items (2) to (6),

wherein a surface of the wall material has a crosslinking group capable of crosslinking with the hydrophilic polymer (A).

(8). The hydrophilic composition according to any of items (2) to (7),

wherein the crosslinking group of the wall material is a hydrolyzable silyl group.

(9) The hydrophilic composition according to any of items (1) to (8), further comprising: an initiator or catalyst (C) that accelerates crosslinking of the hydrophilic polymer.

(10) A hydrophilic treated member obtained by a method comprising:

applying the hydrophilic composition according to any of items (1) to (9) to a substrate so as to form an applied hydrophilic composition; and

drying the applied hydrophilic composition to form a film having a thickness of from 10 nm to 1100 μm.

(11) The hydrophilic treated member according to item (10),

wherein the hydrophilic composition is applied by a spray coating method, a spin coating method, a dip coating method, a roll coating method, a flow coating method, a bar coating method or a coating method using a sponge.

### DETAILED DESCRIPTION OF THE INVENTION

The hydrophilic polymer containing a crosslinking group (A) and the water-in-oil-in-water type (hereinafter also referred to as W/O/W type) emulsion (B), contained in the hydrophilic compound of the present invention, are described below.

### ((A) Hydrophilic Polymer Containing Crosslinking Group)

The crosslinking group in the hydrophilic polymer containing a crosslinking group (A) (hereinafter referred to as a “specific hydrophilic polymer”) is not particularly limited, but examples thereof include a vinyl group, an epoxy group, an isocyanate group, a hydrolyzable silyl group, a hydroxyl group, a carboxyl group and an amino group. Among these, most preferred is a hydrolyzable silyl group capable of producing a silanol group that is not only a crosslinking group but also a hydrophilic group. Also, two or more kinds of crosslinking groups may be use in combination.

The hydrophilic group in the specific hydrophilic polymer (A) is —OH, —ORₐ, —CORₐ, —CO₂Rₑ, —CON(Rₐ)(R_{b}), —N(Rₐ)(R_{b}), —NHCOR_{d}, —NHCO₂Rₐ, —OCON(Rₐ)(R_{b}), —NHCON(Rₐ)(R_{b}), —SO₃Rₑ, —OSO₃Rₑ, —SO₂R_{d}, —NHSO₂R_{d}, —SO₂N(Rₐ)(R_{b}), —N(Rₐ)(R_{b})(R_{c}), —N(Rₐ)(R_{b})(R_{c})(R_{g}), —PO₃(Rₑ)(R_{f}), —OPO₃(Rₑ)(R_{f}) or —PO₃(R_{d})(R_{c}), wherein Rₐ, R_{b} and R_{c} each independently represents a hydrogen atom or an alkyl group (preferably a linear, branched or cyclic alkyl group having a carbon-number of 1 to 8), R_{d} represents an alkyl group preferably a linear, branched or cyclic alkyl group having a carbon number of 1 to 8), Rₑ and R_{f} each independently represents a hydrogen atom, an alkyl group (preferably a linear, branched or cyclic alkyl group having a carbon number of 1 to 8), an alkali metal, an alkaline earth metal or an onium, and R_{g} represents an alkyl group (preferably a linear, branched or cyclic alkyl group having a carbon number of 1 to 8), a halogen atom, an inorganic anion or an organic anion.

A compound particularly preferred as the specific hydrophilic polymer (A) is described below.

The specific hydrophilic polymer is preferably a polymer having structural units represented by the following formulae (I-a) and (I-b)

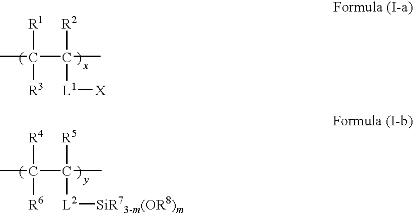

In formulae (I-a) and (I-b), R¹ to R⁸ each independently represents a hydrogen atom or a hydrocarbon group (preferably having a carbon number of 8 or less). L¹ represents a single bond or a polyvalent organic linking group. L² represents a single bond or a polyvalent organic linking group having one or more structures selected from the group consisting of —CONH—, —NHCONH—, —OCONH—, —SO₂NH— and —SO₃—. m represents an integer of 1 to 3. x and y define the compositional ratio and each represents a number satisfying x+y=100 in ranges of 0<x<100 and 0<y<100. X represents —OH, —ORₐ, —CORₐ, —CO₂Rₑ, —CON(Rₐ)(R_{b}), —N(Rₐ)(R_{b}), —NHCOR_{d}, —NHCO₂Rₐ, —OCON(Rₐ)(R_{b}), —NHCON(Rₐ)(R_{b}), —SO₃Rₑ, —OSO₃Rₑ, —SO₂R_{d}, —NHSO₂R_{d}, —SO₂N(Rₐ)(R_{b}), —N(Rₐ)(R_{b})(R_{c}), —N(Rₐ)(R_{b})(R_{c})(R_{g}), —PO₃(Rₑ)(R_{f}), —OPO₃(Rₑ)(R_{f}) or —PO₃(R_{d})(Rₑ), wherein Rₐ, R_{b} and R_{c} each independently represents a hydrogen atom or an alkyl group (preferably a linear, branched or cyclic alkyl group having a carbon number of 1 to 8), R_{d} represents an alkyl group (preferably a linear, branched or cyclic alkyl group having a carbon number of 1 to 8), Rₑ and R_{f} each independently represents a hydrogen atom, an alkyl group (preferably a linear, branched or cyclic alkyl group having a carbon number of 1 to 8), an alkali metal, an alkaline earth metal or an onium, and R_{g} represents an alkyl group (preferably a linear, branched or cyclic alkyl group having a carbon number of 1 to 8), a halogen atom, an inorganic anion or an organic anion.

Examples of the hydrocarbon group, when R¹ to R⁸ each represents a hydrocarbon group, include an alkyl group and an aryl group. Among them, a linear, branched or cyclic alkyl group having a carbon number of 1 to 8 is preferred. Specific examples thereof include a methyl group, an ethyl group, a propyl group, a butyl group, a pentyl group, a hexyl group, a heptyl group, an octyl group, an isopropyl group, an isobutyl group, an s-butyl group, a tert-butyl group, an isopentyl group, a neopentyl group a 1-methylbutyl group, an isohexyl group, a 2-ethylhexyl group, a 2-methylhexyl group and a cyclopentyl group.

In view of the effect and easy availability, R¹ to R⁸ each is preferably a hydrogen atom, a methyl group or an ethyl group.

These hydrocarbon groups each may further have a substituent. When the alkyl group has a substituent, the substituted alkyl group is constituted by the bonding of the substituent to an alkylene group, and the substituent used here is a monovalent nonmetallic atomic group excluding hydrogen. Preferred examples thereof include a halogen atom (e.g., —F, —Br, —Cl, —I), a hydroxyl group, an alkoxy group, an aryloxy group, a mercapto group, an alkylthio group, an arylthio group, an alkyldithio group, an aryldithio group, an amino group, an N-alkylamino group, an N,N-diarylamino group, an N-alkyl-N-arylamino group, an acyloxy group, a carbamoyloxy group, an N-alkylcarbamoyloxy group, an N-arylcarbamoyloxy group, an N,N-dialkylcarbamoyloxy group, an N,N-diarylcarbamoyloxy group, an N-alkyl-N-arylcarbamoyloxy group, an alkylsulfoxy group, an arylsulfoxy group, an acylthio group, an acylamino group, an N-alkylacylamino group, an N-arylacylamino group, a ureido group, an N′-alkylureido group, an N′,N′-dialkylureido group, an N′-arylureido group, an N′,N′-diarylureido group, an N′-alkyl-N′-arylureido group, an N-alkylureido group, an N-arylureido group, an N′-alkyl-N-alkylureido group, an N′-alkyl-N-arylureido group, an N′,N′-dialkyl-N-alkylureido group, an N′,N′-dialkyl-N-arylureido group, an N′-aryl-N-alkylureido group, an N′-aryl-N-arylureido group, an N′,N′-diaryl-N-alkylureido group, an N′,N′-diaryl-N-arylureido group, an N′-alkyl-N′-aryl-N-alkylureido group, an N′-alkyl-N′-aryl-N-arylureido group, an alkoxycarbonylamino group, an aryloxycarbonyl-amino group, an N-alkyl-N-alkoxycarbonylamino group, an N-alkyl-N-aryloxy-carbonylamino group, an N-aryl-N-alkoxycarbonylamino group, an N-aryl-N-aryloxycarbonylamino group, a formyl group, an acyl group (G¹CO—), a carboxyl group, an alkoxycarbonyl group, an aryloxycarbonyl group, a carbamoyl group, an N-alkylcarbamoyl group, an N,N-dialkylcarbamoyl group, an N-arylcarbamoyl group, an N,N-diarylcarbamoyl group, an N-alkyl-N-arylcarbamoyl group, an alkylsulfinyl group, an arylsulfinyl group, an alkylsulfonyl group, an arylsulfonyl group, a sulfo group (—SO₃H) and a conjugate base group thereof (hereinafter referred to as a “sulfonato group”), an alkoxysulfonyl group, an aryloxysulfonyl group, a sulfinamoyl group, an N-alkylsulfinamoyl group, an N,N-dialkylsulfinamoyl group, an N-arylsulfinamoyl group, an N,N-diarylsulfamoyl group, an N-alkyl-N-arylsulfinamoyl group, a sulfamoyl group, an N-alkylsulfamoyl group, an N,N-dialkylsulfamoyl group, an N-arylsulfamoyl group, an N,N-diarylsulfamoyl group, an N-alkyl-N-arylsulfamoyl group, a phosphono group (—PO₃H₂) and a conjugate base group thereof (hereinafter referred to as a “phosphonato group”), a dialkylphosphono group (—PO₃(alkyl)₂), a diarylphosphono group (—PO₃(aryl)₂), an alkylarylphosphono group (—PO₃(alkyl)(aryl)), a monoalkylphosphono group (—PO₃H(alkyl)) and a conjugate base group thereof (hereinafter referred to as an “alkylphosphonato group”), a monoarylphosphono group (—PO₃H(aryl)) and a conjugate base group thereof (hereinafter referred to as an “arylphosphonato group”), a phosphonoxy group (—OPO₃H₂) and a conjugate base group thereof hereinafter referred to as a “phosphonatoxy group”), a dialkylphosphonoxy group (—OPO₃(alkyl)₂), a diarylphosphonoxy group (—OPO₃(aryl)₂), an alkylarylphosphonoxy group (—OPO(alkyl)(aryl)), a monoalkylphosphonoxy group (—OPO₃H(alkyl)) and a conjugate base group thereof (hereinafter referred to as an “alkylphosphonatoxy group”), a monoarylphosphonoxy group (—OPO₃H(aryl)) and a conjugate base group thereof (hereinafter referred to as an “arylphosphonatoxy group”), a morpholino group, a cyano group, a nitro group, an aryl group, an alkenyl group and an alkynyl group.

In these substituents, specific examples of the alkyl group include those described for the alkyl group of R¹ to R⁸, and specific examples of the aryl group include a phenyl group, a biphenyl group, a naphthyl group, a tolyl group, a xylyl group, a mesityl group, a cumenyl group, a chlorophenyl group, a bromophenyl group, a chloromethylphenyl group, a hydroxyphenyl group, a methoxyphenyl group, an ethoxyphenyl group, a phenoxyphenyl group, an acetoxyphenyl group, a benzoyloxyphenyl group, a methylthiophenyl group, a phenylthiophenyl group, a methylaminophenyl group, a dimethylaminophenyl group, an acetylammiophenyl group, a carboxyphenyl group, a methoxycarbonylphenyl group, an ethoxyphenylcarbonyl group, a phenoxycarbonylphenyl group, an N-phenylcarbamoylphenyl group, a phenyl group, a cyanophenyl group, a sulfophenyl group, a sulfonatophenyl group, a phosphonophenyl group and a phosphonatophenyl group. Examples of the alkenyl group include a vinyl group, a 1-propenyl group, a 1-butenyl group, a cinnamyl group and a 2-chloro-1-ethenyl group, and examples of the alkynyl group include an ethynyl group, a 1-propynyl group, a 1-butynyl group and a trimethylsilylethynyl group. Examples of G¹ in the acyl group (G¹CO—) include hydrogen and the above-described alkyl and aryl groups.

Among these substituents, more preferred are a halogen atom (e.g., —F, —Br, —Cl, 4), an alkoxy group, an aryloxy group, an alkylthio group, an arylthio group, an N-alkylamino group, an N,N-dialkylamino group, an acyloxy group, an N-alkylcarbamoyloxy group, an N-arylcarbamoyloxy group, an acylamino group, a formyl group, an acyl group, a carboxyl group, an alkoxycarbonyl group, an aryloxycarbonyl group, a carbamoyl group, an N-alkylcarbamoyl group; an N,N-dialkylcarbamoyl group, an N-arylcarbamoyl group, an N-alkyl-N-arylcarbamoyl group, a sulfo group, a sulfonato group, a sulfamoyl group, an N-alkylsulfamoyl group, an N,N-dialkylsulfamoyl group, an N-arylsulfamoyl group, an N-alkyl-N-arylsulfamoyl group, a phosphono group, a phosphonato group, a dialkylphosphono group, a diarylphosphono group, a monoalkylphosphono group, an alkylphosphonato group, a monoarylphosphono group, an arylphosphonato group, a phosphonoxy group, a phosphonatoxy group, an aryl group and an alkenyl group.

The alkylene group in the substituted alkyl group is preferably a divalent organic residue resulting from removal of any one hydrogen atom on an alkyl group having a carbon number of 1 to 20, more preferably a linear alkylene group having a carbon number of 1 to 12, a branched alkylene group having a carbon number of 3 to 12 or a cyclic alkylene group having a carbon number of 5 to 10. Specific preferred examples of the substituted alkyl group obtained by combining the above-described substituent and an alkylene group include a chloromethyl group, a bromomethyl group, a 2-chloroethyl group, a trifluoromethyl group, a methoxymethyl group, a methoxyethoxyethyl group, an allyloxymethyl group, a phenoxymethyl group, a methylthiomethyl group, a tolylthiomethyl group, an ethylaminoethyl group, a diethylaminopropyl group, a morpholinopropyl group, an acetyloxymethyl group, a benzoyloxymethyl group, an N-cyclohexylcarbamoyloxyethyl group, an N-phenylcarbamoyloxyethyl group, an acetyl-aminoethyl group, an N-methylbenzoylaminopropyl group, a 2-oxyethyl group, a 2-oxypropyl group, a carboxypropyl group, a methoxycarbonylethyl group, an allyloxycarbonylbutyl group, a chlorophenoxycarbonylmethyl group, a carbamoylmethyl group, an N-methylcarbamoylethyl group, an N,N-dipropylcarbarnoylmethyl group, an N-(methoxyphenyl)carbamoylethyl group, an N-methyl-N-(sulfophenyl)carbamoylmethyl group, a sulfobutyl group, a sulfonatobutyl group, a sulfamoylbutyl group, an N-ethylsulfamoylmethyl group, an N,N-dipropylsulfamoylpropyl group, an N-tolylsulfamoylpropyl group, an N-methyl-N-(phosphonophenyl)sulfamoyloctyl group, a phosphonobutyl group, a phosphonatohexyl group, a diethylphosphonobutyl group, a diphenylphosphonopropyl group, a methylphosphonobutyl group, a methylphosphonato-butyl group, a tolylphosphonohexyl group, a tolylphosphonatohexyl group, a phosphonoxypropyl group, a phosphonatoxybutyl group, a benzyl group, a phenethyl group, an α-methylbenzyl group, a 1-methyl-1-phenylethyl group, a p-methylbenzyl group, a cinnamyl group, an allyl group, a 1-propenylmethyl group, a 2-butenyl group, a 2-methylallyl group, a 2-methylpropenylmethyl group, a 2-propynyl group, a 2-butynyl group and a 3-butynyl group,

L¹ represents a single bond or a polyvalent organic linking group. Here, the single bond indicates that the polymer main chain and X are directly bonded without a; linking chain. Furthermore, the organic linking group indicates a linking group composed of a nonmetallic atom and is specifically a linking group composed of from 0 to 200 carbon atoms, from 0 to 150 nitrogen atoms, from 0 to 200 oxygen atoms, from 0 to 400 hydrogen atoms and from 0 to 100 sulfur atoms. More specific examples of the linking group include those comprising one of the following structural units or a combination thereof.

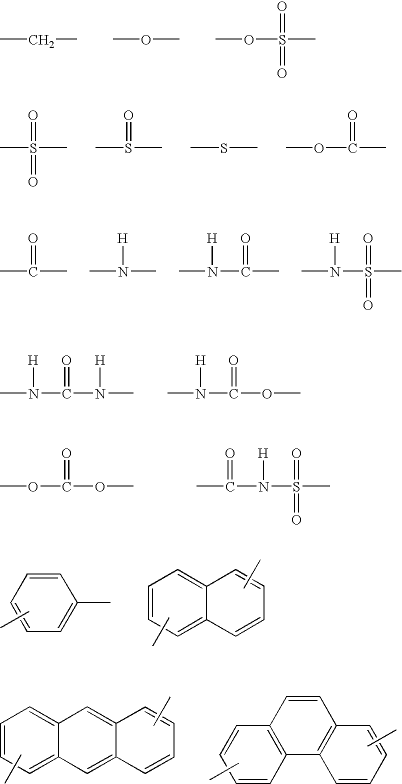

L¹ may be formed of a polymer or an oligomer and specifically, it is preferred to contain polyacrylate, polymethacrylate, polyacrylonitrile, polyvinyl, polystyrene or the like each containing an unsaturated double bond-based monomer. Other preferred examples include poly(oxyalkylene), polyurethane, polyurea, polyester, polyamide, polyimide, polycarbonate, polyamino acid and polysiloxane. Above all, polyacrylate, polymethacrylate, polyacrylonitrile, polyvinyl and polystyrene are preferred, and polyacrylate, polymethacrylate are more preferred.

The polymer or oligomer may be constituted by one kind or two or more kinds of these structural units. Also, when L¹ is a polymer or an oligomer, the number of constituent elements is not limited, and the molecular weight is preferably from 1,000 to 1,000,000, more preferably from 1,000 to 500,000, and most preferably from 1,000 to 200,000.

L² represents a single bond or a polyvalent organic linking group having one or more structures selected from —CONH—, —NHCONH—, —OCONH—, —SO₂NH— or —SO₃—. Here, the single bond indicates that the polymer main chain and an Si atom are directly bonded without a linking group. In L², two or more of the above-described structures may be present and in this case, the structures may be the same or different. As long as L² contains one or more above-described structures, the other structure may be the same structure as those described for L¹.

X is a hydrophilic group and represents —OH, —ORₐ, —CORₐ, —CO₂Rₑ, —CON(Rₐ)(R_{b}), —N(Rₐ)(R_{b}), —NHCOR_{d}, —NHCO₂Rₐ, —OCON(Rₐ)(R_{b}), —NHCON(Rₐ)(R_{b}), —SO₃Rₑ, —OSO₃Rₑ, —SO₂R_{d}, —NHSO₂R_{d}, —SO₂N(Rₐ)(R_{b}), —N(Rₐ)(R_{b})(R_{c}), —N(Rₐ)(R_{b})(R_{c})(R_{g}), —PO₃(Rₑ)(R_{f}), —OPO₃(Rₑ)(R_{f}) or —PO₃(R_{d})(Rₑ), wherein Rₐ, R_{b} and R_{c} each independently represents a hydrogen atom or an alkyl group (preferably a linear, branched or cyclic alkyl group having a carbon number of 1 to 8), R_{d} represents an alkyl group (preferably a linear, branched or cyclic alkyl group having a carbon number of 1 to 8), Rₑ and R_{f} each independently represents a hydrogen atom, an alkyl group (preferably a linear, branched or cyclic alkyl group having a carbon number of 1 to 8), an alkali metal, an alkaline earth metal or an onium, and R_{g} represents an alkyl group (preferably a linear, branched or cyclic alkyl group having a carbon number of 1 to 8), a halogen atom, an inorganic anion or an organic anion.

As regards —CON(Rₐ)(R_{b}), —OCON(Rₐ)(R_{b}), —NHCON(Rₐ)(R_{b}), —SO₂N(Rₐ)(R_{b}), —PO₃(Rₑ)(R_{f}), —OPO₃(Rₑ)(R_{f}), —PO₃(R_{d})(Rₑ), —N(Rₐ)(R_{b})(R_{c}) and —N(Rₐ)(R_{b})(R_{c})(R_{g}), Rₐ, to R_{g} may combine with each other to form a ring, and the ring formed may be a heterocyclic ring containing a heteroatom such as oxygen atom, sulfur atom and nitrogen atom. Rₐ to R_{g} each may further have a substituent, and examples of the substituent which can be introduced here include those described above as the introducible substituent when R¹ to R⁸ each is an alkyl group.

Specific preferred examples of Rₐ, R_{b} and R_{c} include a hydrogen atom, a methyl group, an ethyl group, a propyl group, a butyl group, a pentyl group, a hexyl group, a heptyl group, an octyl group, an isopropyl group, an isobutyl group, an s-butyl group, a tert-butyl group, an isopentyl group, a neopentyl group, a 1-methylbutyl group, an isohexyl group, a 2-ethylhexyl group, a 2-methylhexyl group and a cyclopentyl group.

Specific preferred examples of R_{d} include a methyl group, an ethyl group, a propyl group, a butyl group, a pentyl group, a hexyl group, a heptyl group, an octyl group, an isopropyl group, an isobutyl group, an s-butyl group, a tert-butyl group, an isopentyl group, a neopentyl group, a 1-methylbutyl group, an isohexyl group, a 2-ethylhexyl group, a 2-methylhexyl group and a cyclopentyl group.

Specific examples of Rₑ and R_{f} include, in addition to the alkyl group described for Rₐ to R_{d}, a hydrogen atom, an alkali metal such as lithium, sodium and potassium, an alkaline earth metal such as calcium and barium, and an onium such as ammonium, iodonium and sulfonium.

Specific examples of R_{g} include, in addition to the alkyl group described for Rₐ to R_{d}, a hydrogen atom, a halogen atom such as fluorine atom, chlorine atom and bromine atom, an inorganic anion such as nitrate anion, sulfate anion, tetrafluoroborate anion and hexafluorophosphate anion, and an organic anion such as methanesulfonate anion, trifluoromethanesulfonate anion, nonafluorobutanesulfonate anion and p-toluenesulfonate anion.

Specific preferred examples of X include —CO₂⁻Na⁺, —CONH₂, —SO₃⁻Na⁺, —SO₂NH₂ and —PO₃H₂.

x and y define the compositional ratio between the structural unit represented by formula (I-a) and the structural unit represented by formula (I-b) in the specific hydrophilic polymer (A). x and y define the compositional ratio and each represents a number satisfying x+y=100 in ranges of 0<4<100 and 0<y<100. x:y is preferably from 99:1 to 10:90, more preferably from 99:1 to 50:50, and most preferably from 95:5 to 70:30. By setting the molar ratio of respective monomers to fall within this range, an effect of bringing out high stability of the coating solution, high film strength and hydrophilicity can be provided.

As regards each of the structural units (I-a) and (I-b) constituting the polymer chain, all may be the same, or a plurality of different structural units may be contained and in this case, the compositional ratio between the structural units corresponding to formula (I-a) and the structural units corresponding to formula (I-b) is preferably in the above-described range.

The mass average molecular weight of the specific hydrophilic polymer (A) is preferably from 1,000 to 1,000,000, more preferably from 1,000 to 500,000, and most preferably from 1,000 to 200,000.

Specific examples [Compounds (1) to (50)] of the specific hydrophilic polymer (A) are set forth below together with the mass average molecular weight (M.W.) thereof, but the present invention is not limited thereto. In specific examples below, the polymer is a random copolymer where respective structural units shown are contained in the indicated molar ratio.

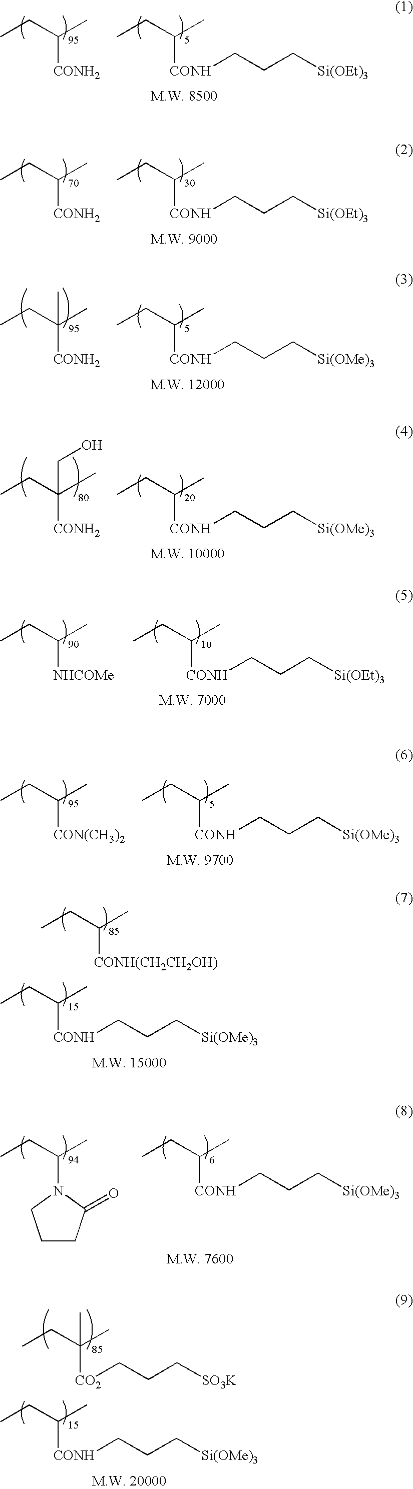

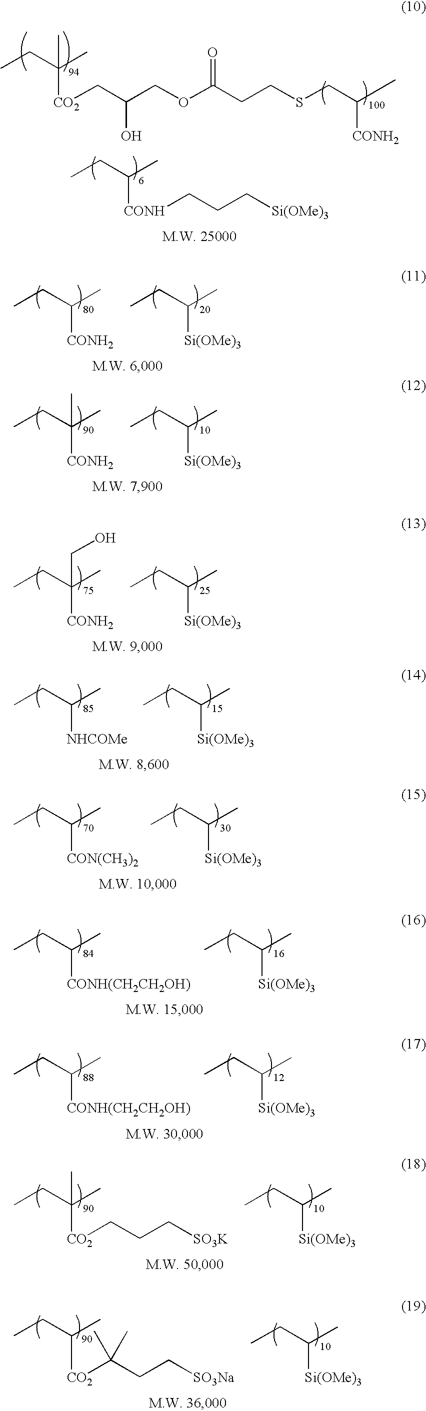

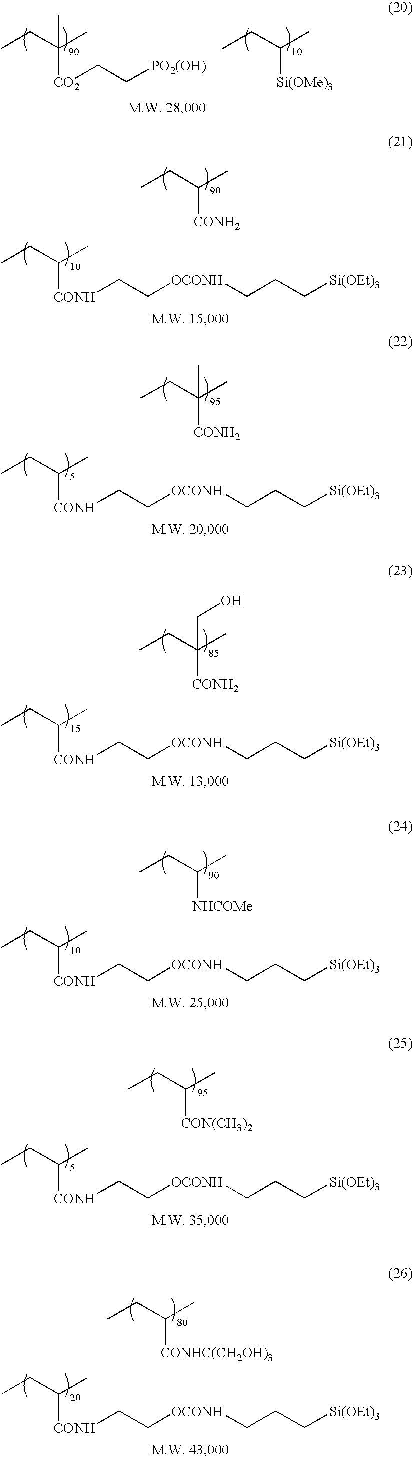

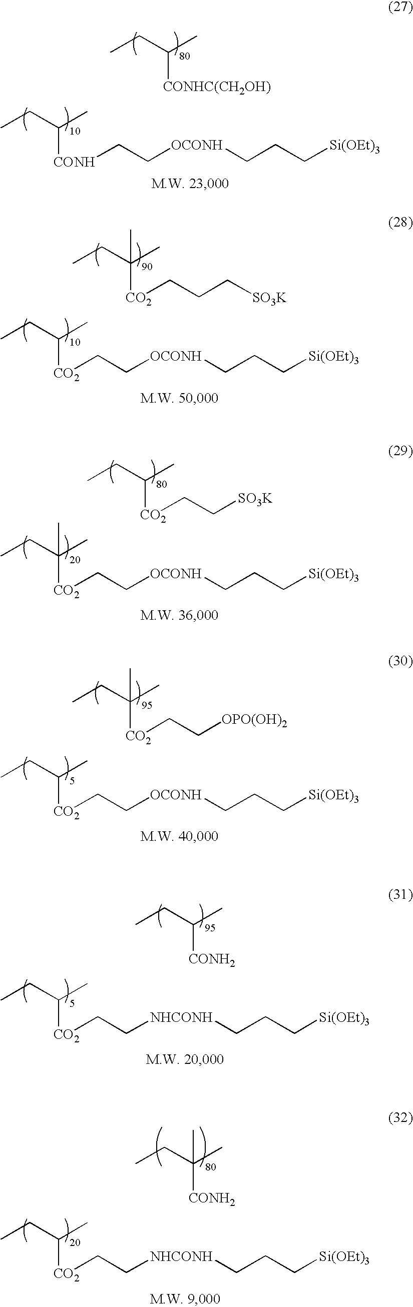

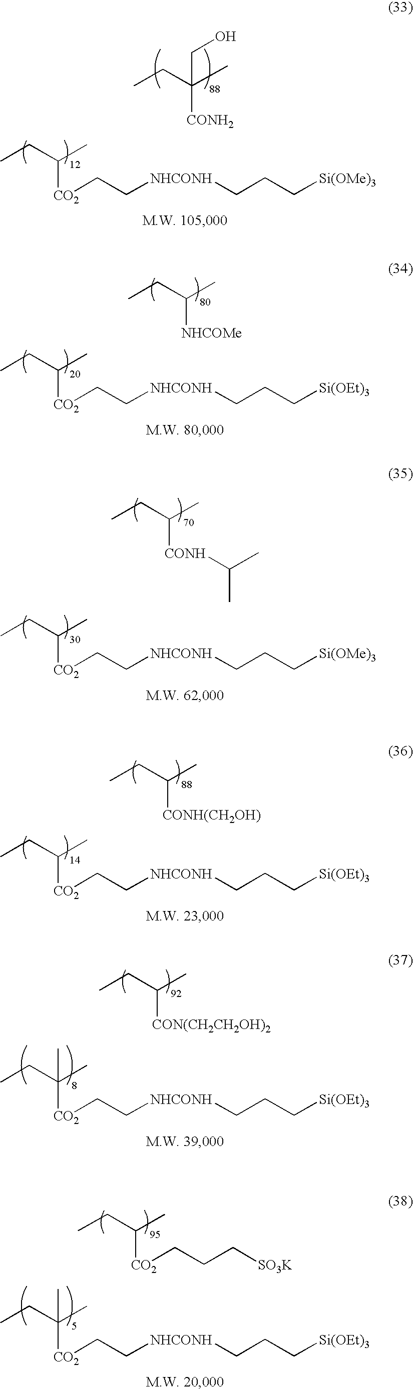

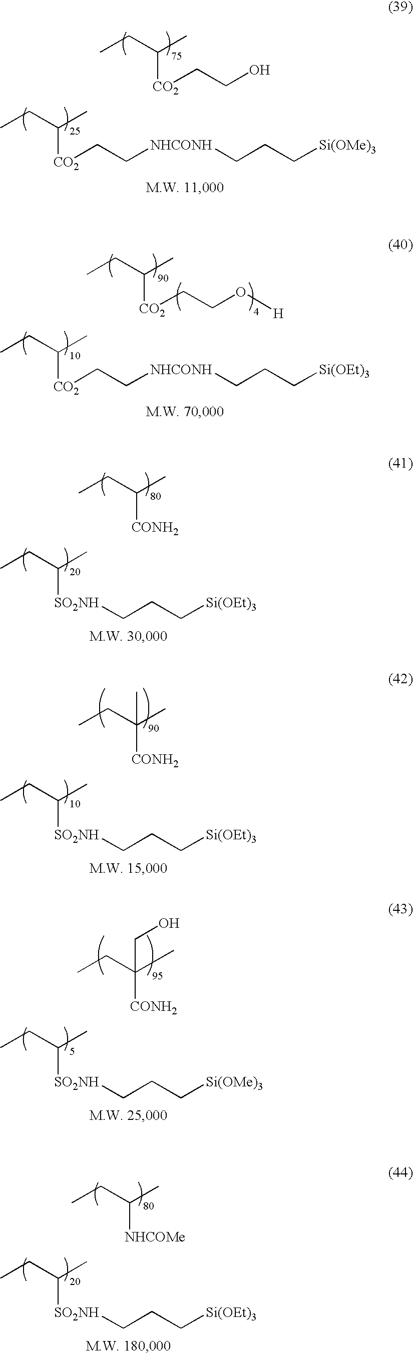

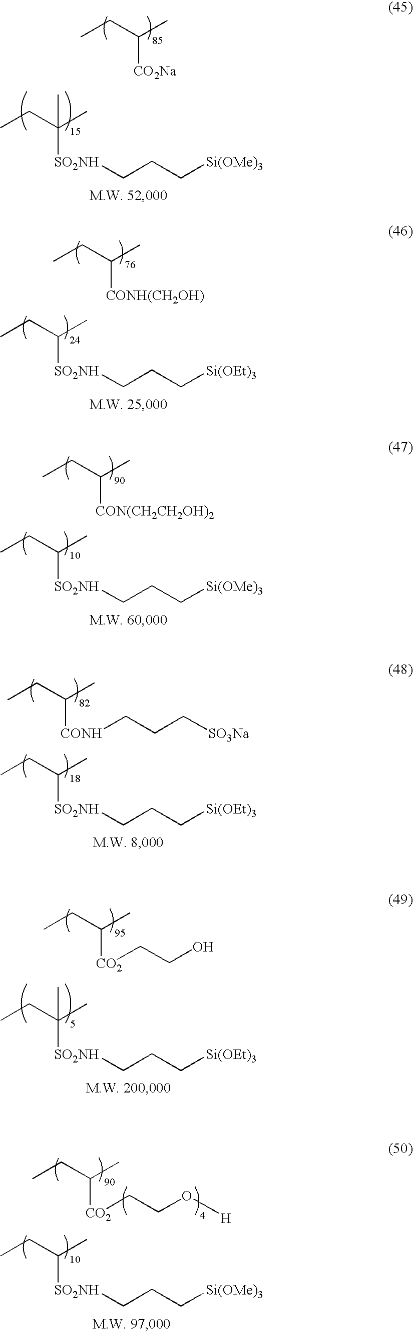

The raw material compound for the synthesis of the specific hydrophilic polymer (A) is commercially available or can be easily synthesized.

As regards the method for synthesizing the specific hydrophilic polymer (A), any of conventionally known radical polymerization methods may be used. The general radical polymerization methods are specifically described, for example, in Shin Kobunshi Jikken Gaku 3, Kobunshi no Gousei to Hanno 1 (New Polymer Experimentation 3, Synthesis and Reaction of Polymers 1), compiled by Polymer Society Japan, Kyoritsu Shuppan, Shin Jikken Kagaku Koza 19, Kobunshi Kagaku (I) (Lecture on New Experimental Chemistry 19, Polymer Chemistry (I)), compiled by The Chemical Society of Japan, Maruzen, and Busshitsu Kogaku Koza, Kobunshi Gousei Kagaku (Lecture on Substance Engineering, Polymer Synthesis Chemistry), Publishing Division of Tokyo Denki University, and these can be applied.

The specific hydrophilic polymer may also be a copolymer with other monomers described below. Examples of the other monomer used include known monomers such as acrylic acid esters, methacrylic acid esters, acrylamides, methacrylamides, vinyl esters, styrenes, acrylic acid, methacrylic acid, acrylonitrile, maleic acid anhydride and maleic acid imide. By copolymerizing such monomers, various properties such as film-forming property, film strength, hydrophilicity, hydrophobicity, solubility, reactivity and stability can be improved.

Specific examples of the acrylic acid esters include methyl acrylate, ethyl acrylate, (n- or i-)propyl acrylate, (n-, i-, sec- or tert-)butyl acrylate, amyl acrylate, 2-ethylhexyl acrylate, dodecyl acrylate, chloroethyl acrylate, 2-hydroxyethyl acrylate, 2-hydroxypropyl acrylate, 2-hydroxypentyl acrylate, cyclohexyl acrylate, allyl acrylate, trimethylolpropane monoacrylate, pentaerythritol monoacrylate, glycidyl acrylate, benzyl acrylate, methoxybenzyl acrylate, chlorobenzyl acrylate, hydroxybenzyl acrylate, hydroxyphenethyl acrylate, dihydroxyphenethyl acrylate, furfuryl acrylate, tetrahydrofurfuryl acrylate, phenyl acrylate, hydroxyphenyl acrylate, chlorophenyl acrylate, sulfamoylphenyl acrylate and 2-(hydroxyphenylcarbonyloxy)ethyl acrylate.

Specific examples of the methacrylic acid esters include methyl methacrylate, ethyl methacrylate, (n- or i-)propyl methacrylate, (n-, i-, sec- or tert-)butyl methacrylate, amyl methacrylate, 2-ethylhexyl methacrylate, dodecyl methacrylate, chloroethyl methacrylate, 2-hydroxyethyl methacrylate, 2-hydroxypropyl methacrylate, 2-hydroxypentyl methacrylate, cyclohexyl methacrylate, allyl methacrylate, trimethylolpropane monomethacrylate, pentaerythritol monomethacrylate, glycidyl methacrylate, methoxybenzyl methacrylate, chlorobenzyl methacrylate, hydroxybenzyl methacrylate, hydroxyphenethyl methacrylate, dihydroxyphenethyl methacrylate, furfuryl methacrylate, tetrahydrofurfuryl methacrylate, phenyl methacrylate, hydroxyphenyl methacrylate, chlorophenyl methacrylate, sulfamoylphenyl methacrylate and 2-(hydroxyphenylcarbonyloxy)ethyl methacrylate.

Specific examples of the acrylamides include acrylamide, N-methylacrylamide, N-ethylacrylamide, N-propylacrylamide, N-butylacrylamide, N-benzylacrylamide, N-hydroxyethylacrylamide, N-phenylacrylamide, N-tolylacrylamide, N-(hydroxyphenyl)acrylamide, N-(sulfamoylphenyl)acrylamide, N-(phenylsulfonyl)acrylamide, N-(tolylsulfonyl)acrylamide, N,N-dimethylacrylamide, N-methyl-N-phenylacrylamide and N-hydroxyethyl-N-methylacrylamide.

Specific examples of the methacrylamides include methacrylamide, N-methylmethacrylamide, N-ethylmethacrylamide, N-propylmethacrylamide, N-butylmethacrylamide, N-benzylmethacrylamide, N-hydroxyethylmethacrylamide, N-phenylmethacrylamide, N-tolylmethacrylamide, N-(hydroxyphenyl)methacrylamide, N-(sulfamoylphenyl)methacrylamide, N-(phenylsulfonyl)methacrylamide, N-(tolylsulfonyl)methacrylamide, N,N-dimethylmethacrylamide, N-methyl-N-phenylmethacrylamide and N-hydroxyethyl-N-methylmethacrylamide.

Specific examples of the vinyl esters include vinyl acetate, vinyl butyrate and vinyl benzoate.

Specific examples of the styrenes include styrene, methylstyrene, dimethylstyrene, trimethylstyrene, ethylstyrene, propylstyrene, cyclohexylstyrene, chloromethylstyrene, trifluoromethylstyrene, ethoxymethylstyrene, acetoxymethylstyrene, methoxystyrene, dimethoxystyrene, chlorostyrene, dichlorostyrene, bromostyrene, iodostyrene, fluorostyrene and carboxystyrene.

As for the proportion of the other monomer that is used for the synthesis of the copolymer, the amount used needs to be large enough to improve various properties but in order to ensure that the function as a hydrophilic film is satisfied and a sufficient advantage attributable to the addition of the specific hydrophilic polymer (A) is obtained, the proportion is preferably not too much large. Accordingly, the total proportion of the other monomer in the specific hydrophilic polymer (A) is preferably 80 mass % or less, more preferably 50 mass % or less.

### ((B) W/O/W Emulsion)

The W/O/W emulsion is composed of an outer aqueous phase, a wall material and an inner aqueous phase. The wall material of the W/O/W emulsion is located between the inner aqueous phase and the outer aqueous phase. The W/O/W emulsion means, for example, a hydrophobic particle containing inside a hydrophilic resin (i.e. a capsule which capsulates a hydrophilic resin) and dispersed in an aqueous solution.

The outer aqueous phase of the W/O/W emulsion enables the W/O/W emulsion to mix and disperse in the specific hydrophilic polymer.

The outer aqueous phase of the W/O/W emulsion is not particularly limited, but examples thereof are water-soluble solvents including water; alcohols such as a methyl alcohol, an ethyl alcohol, an isopropanol, a t-butanol, an ethylene glycol and a propylene glycol; ketones such as an acetone and a methyl ethyl ketone; ethers such as an ethylene glycol monomethyl ether, a diethylene glycol monobutyl ether, a tetrahydrofuran and a dioxane; esters such as an ethyl acetate and an ethyl lactate; carboxylic acids such as an acetic acid and a lactic acid; and polar aprotic solvents such as a dimethyl sulfoxide, a dimethylformamide and a pyridine.

The wall material of the W/O/W emulsion provides flexibility to the hydrophilic film formed from the specific hydrophilic polymer so as to enhance scratch resistance of the hydrophilic film. The wall material of the W/O/W emulsion is not particularly limited, but examples thereof include a polyester resin, a polyamide resin, an acrylic resin, a vinyl resin, a hydrocarbon resin, an epoxy resin, a urethane resin, a urea resin, an acrylic silicon resin and a polyamide resin. Above all, a hydrophobic resin is preferred. Specific preferred examples of the wall material include an acrylic resin, a urethane resin and a urea resin.

The wall material surface of the W/O/W emulsion is preferably coated with a polymer dispersant in order to disperse in outer aqueous solution.

The wall material surface of the W/O/W emulsion is preferably subjected to a hydrophilization treatment in order to disperse in water Examples of the method therefor include a method of adsorbing a surfactant, and a method of reacting the wall material with a hydrophilic compound contained in the outer aqueous phase.

The wall material surface of the W/O/W emulsion preferably has a crosslinking group so as to crosslink with the above-described specific hydrophilic polymer. The crosslinking group is not particularly limited as long as it can crosslink with the specific hydrophilic polymer, but examples thereof include a vinyl group, an epoxy group, an isocyanate group, a hydrolyzable silyl group, a hydroxyl group, a carboxyl group and an amino group. Among these, a hydrolyzable silyl group is preferred.

The crosslinking group can be introduced into the wall material surface by mixing the outer aqueous phase or wall material with a compound having a crosslinking group and a functional group capable of reacting with the wall material.

The inner aqueous phase of the W/O/W emulsion may be solid or liquid and is not particularly limited as long as it is hydrophilic. The inner aqueous phase of the W/O/W emulsion is a hydrophilic resin so as to prevent the lowering of the hydrophilic property of the hydrophilic film even when the wall material is destroyed and the inner aqueous phase diffuses to the specific hydrophilic polymer. Examples thereof include a low molecular compound such as surfactant, and a polymer compound such as polyacrylamide, polyvinylpyrrolidone, polyethylene glycol, polyethylene oxide, polyvinyl alcohol, polyvinylsulfonic acid and polyacrylic acid. Among these, preferred are polyvinylpyrrolidone, polyethylene glycol and polyethylene oxide which are difficult to interact in a dry state.

### (Emulsification Method)

The emulsification of the W/O/W emulsion is performed by a known dispersing method, for example, an intermittent shaking method, a method using a mixer such as propeller-type stirrer or turbine-type stirrer, a colloid mill method, a homogenizer method, an ultrasonic irradiation method or a film emulsification method.

### (Preparation Method of Emulsion)

As for the emulsifying apparatus, a known apparatus such as simple stirrer, impeller stirring system, in-line stirring system, mill system (e.g., colloid mill) and ultrasonic system may be used, but use of a high-pressure homogenizer is particularly preferred.

The mechanism of the high-pressure homogenizer is described in detail, for example, in U.S. Pat. No. 4,533,254 and JP-A-647264, examples of the commercially available apparatus include Gaulin Homogenizer (manufactured by A.P.V Gaulin Inc.), Microfluidizer (manufactured by Microfluidex Inc.) and Altimizer (produced by Sugino Machine).

The high-pressure homogenizer having a mechanism of effecting pulverization in an ultrahigh pressure jet stream described in U.S. Pat. No. 5,720,551 is particularly preferable for the emulsion-dispersion of the present invention. Examples of the emulsifying apparatus using this ultrahigh pressure jet stream include DeBEE2000 (manufactured by BEE International Ltd.).

In recent years, a film emulsification method capable of controlling the particle diameter of the emulsion by the pore size of a film, of which mechanism is described in detail in JP-A-4-323224 and the like, has been developed. According to this technique, an emulsion having a uniform particle diameter can be obtained.

### (Particle Diameter)

The particle diameter of the W/O/W emulsion (i.e. the particle diameter of oil-in-water emulsion dispersed in the outer aqueous phase) is not particularly limited but is preferably from 50 nm to 100 μm and for enhancing the scratch resistance or water-rubbing resistance, more preferably from 100 nm to 10 μm.

### (Amount Added)

If the amount of the W/O/W emulsion added is large, reduction in the hydrophilicity may be caused, whereas if the amount added is small, sufficiently flexible film quality is not obtained. Accordingly, the amount added is preferably from 0.1 to 90 mass % based on the solid content of the hydrophilic composition. Also, the W/O/W emulsion is filled to the highest density in the coating film when added in an amount of 70 mass %, and therefore, the amount added is preferably not more than 70 mass %. The solid content of the hydrophilic compound indicates a solid content excluding the solvent that volatilizes.

In the hydrophilic composition of the present invention, in addition to the components (A) and (B), various compounds according to the purpose may be used in combination as long as the effects of the present invention are not impaired.

The components which can be used in combination are described below.

For accelerating the crosslinking of the specific hydrophilic polymer (A) or the crosslinking with the W/O/W emulsion, a catalyst, an initiator and a crosslinking agent may be used.

### (Catalyst)

The hydrophilic composition of the present invention preferably contains, as the catalyst, at least one member selected from an acid, an alkali, a metal chelate and a metal salt. These are described below.

### (Acid)

Examples of the acid catalyst include acetic acid, chloroacetic acid, citric acid, benzoic acid, dimethylmalonic acid, formic acid, propionic acid, glutaric acid, glycolic acid, maleic acid, malonic acid, hydrochloric acid, sulfuric acid, nitric acid, phosphoric acid, oxalic acid, p-toluenesulfonic acid and phthalic acid, with hydrochloric acid and nitric acid being preferred.

### (Alkali)

Examples of the alkali catalyst include ammonia, sodium hydroxide, potassium hydroxide and sodium carbonate, with ammonia and sodium hydroxide being preferred.

### (Metal Chelate)

Examples of the metal chelate include a compound composed of a metal element selected from Group 2A element, Group 313 element, Group 4A element and Group 5A element of the Periodic Table and an oxo- or hydroxyoxygen-containing compound selected from a β-diketone, a ketoester, a hydroxycarboxylic acid or an ester thereof, an aminoalcohol and an enolic active hydrogen compound.

Among the constituent metal elements, preferred are a Group 2A element such as Mg, Ca, Sr and Ba, a Group 3B element such as Al and Ga, a Group 4A element such as Ti and Zr, and a Group 5A element such as V, Nb and Ta. These metal elements each forms a complex having an excellent catalyst effect. Above all, complexes formed from Zr, Al and Ti are excellent and preferred.

Examples of the oxo- or hydroxyoxygen-containing compound constituting the ligand of the metal chelate include β-diketones such as acetylacetone(2,4-pentanedione) and 2,4-heptanedione; ketoesters such as methyl acetoacetate, ethyl acetoacetate and butyl acetoacetate; hydroxycarboxylic acids and esters thereof, such as lactic acid, methyl lactate, salicylic acid, ethyl salicylate, phenyl salicylate, malic acid, tartaric acid and methyl tartrate; ketoalcohols such as 4-hydroxy-4-methyl-2-pentanone, 4-hydroxy-2-pentanone, 4-hydroxy-4-methyl-2-heptanone and 4-hydroxy-2-heptanone; aminoalcohols such as monoethanolamine, N,N-dimethylethanolamine, N-methyl-monoethanolamine, diethanolamine and triethanolamine; enolic active compounds such as methylolmelamine, methylolurea, methylolacrylamide and diethyl malonate; and compounds having a substituent on the methyl group, methylene group or carbonyl carbon of acetylacetone(2,4-pentanediol).

The ligand is preferably acetylacetone or an acetylacetone derivative. The acetylacetone derivative as used in the present invention indicates a compound having a substituent on the methyl group, methylene group or carbonyl carbon of acetylacetone. Examples of the substituent substituted on the methyl group of acetylacetone include an alkyl group, an acyl group, a hydroxyalkyl group, a carboxyalkyl group, an alkoxy group and an alkoxyalkyl group each having a carbon number of 1 to 3 and being linear or branched. Examples of the substituent substituted on the methylene group of acetylacetone include a carboxyl group, a linear or branched carboxyalkyl group and a linear or branched hydroxyalkyl group each having a carbon number of 1 to 3. Examples of the substituent substituted on the carbonyl carbon of acetylacetone include an alkyl group having a carbon number of 1 to 3, and in this case, a hydrogen atom is added to the carbonyl oxygen to form a hydroxyl group.

Specific preferred examples of the acetylacetone derivative include acetylacetone, ethylcarbonylacetone, n-propylcarbonylacetone, i-propylcarbonylacetone, diacetylacetone, 1-acetyl-1-propionyl-acetylacetone, hydroxyethylcarbonylacetone, hydroxypropylcarbonylacetone, acetoacetic acid, acetopropionic acid, diacetoacetic acid, 3,3-diacetopropionic acid, 4,4-diacetobutyric acid, carboxyethylcarbonylacetone, carboxypropylcarbonylacetone, and diacetone alcohol. Among these, acetylacetone and diacetylacetone are more preferred. The complex of this acetylacetone derivative with the metal element above is a mononuclear complex in which from 1 to 4 acetylacetone derivative molecules are coordinated per one metal element, and in the case where the number of coordination bonds of the metal element is larger than the total number of coordination bonds of acetylacetone derivatives, the metal element may be coordinated with a ligand commonly used in a normal complex, such as water molecule, halogen ion, nitro group and ammonia group.

Preferred examples of the metal chelate include a tris(acetylacetonato)aluminum complex salt, a di(acetylacetonato)aluminum•aquo-complex salt, a mono-(acetylacetonato)aluminum•chloro-complex salt, a di(diacetylacetonato)aluminum complex salt, an ethylacetoacetate aluminum diisopropylate, an aluminum tris-(ethylacetoacetate), a cyclic aluminum oxide isopropylate, a tris(acetylacetonato)barium complex salt, a di(acetylacetonato)titanium complex salt, a tris(acetylacetonato)titanium complex salt, a di-i-propoxy•bis(acetylacetonato)titanium complex salt, a zirconium tris(ethylacetoacetate) and a zirconium tris(benzoate) complex salt. These compounds exhibit excellent stability in an aqueous coating solution and provide an excellent effect of accelerating the gelling in a sol-gel reaction at the drying under heat. Above all, an ethylacetoacetate aluminum diisopropylate, an aluminum tris(ethylacetoacetate), a di(acetylacetonato)titanium complex salt and a zirconium tris(ethylacetoacetate) are more preferred.

### (Metal Salt)

A metal salt may also be used in place of the metal chelate above. The typical metal salt includes a halide, oxy-acid salt or organic acid salt of a metal element selected from Groups 2A, 3B, 4A and 5A of the Periodic Table.

Among the metal elements above, preferred are a Group 2A element such as Mg, Ca, Sr and Ba, a Group 3B element such as Al and Ga, a Group 4A element such as Ti and Zr, and a Group 5A element such as V, Nb and Ta. These metal elements each forms a metal salt having an excellent catalyst effect. Above all, metal salts obtained from Zr, and Al are excellent and preferred.

Preferred examples of the metal salt include ZrOCl₂.8H₂, ZrOSO₄.nH₂O, ZrO(N₃)₂.4H₂O, ZrO(CO₃)₂.H₂O, ZrO(OH)₂.nH₂O, ZrO(C₂H₃O₂)₂, (NH₄)₂ZrO(CO₃)₂, ZrO(C₁₈H₂₅O₂)₂, ZrO(C₈H₁₅O₂)₂, AlCl₃, Al₂O₃.H₂O, Al₂O₂.3H₂O, Al₂(SO₄)₃.18H₂O and Al₂(C₂O₄)₃.4H₂O.

### (Initiator)

The initiator applicable to the present invention is not particularly limited, but examples thereof include benzoin alkyl ethers such as benzoin methyl ether and benzoin ethyl ether; acetophenones such as 2,2-diethoxyacetophenone, benzophenone and chloroacetophenones; propiophenones such as 2-hydroxy-2-methylpropiophenone; xanthones such as 2-chlorothioxanthone and 2,4-diethylthioxanthone; anthraquinones such as chloroanthraquinone and ethylanthraquinone; and ketals such as dimethylbenzyl ketal.

### (Crosslinking Agent)

As for the crosslinking agent applicable to the present invention, a known crosslinking agent which forms crosslinking under heat may be used. The thermal crosslinking agent in general includes those described in Shinzo Yamashita and Tosuke Kaneko, Kakyozai Handbook (Crosslinking Agent Handbook), Taiseisha (1981). The crosslinking agent for use in the present invention is not particularly limited as long as it has two or more functional groups and can effectively crosslink with the specific hydrophilic polymer or W/O/W emulsion. Specific examples of the thermal crosslinking agent include a polycarboxylic acid such as polyacrylic acid; an amine compound such as diamine and polyethyleneimine; a polyepoxy compound such as ethylene or propylene glycol diglycidyl ether, tetraethylene glycol diglycidyl ether, nonaethylene glycol diglycidyl ether, polyethylene or polypropylene glycol glycidyl ether, neopentyl glycol diglycidyl ether, 1,6-hexanediol diglycidyl ether, trimethylolpropane triglycidyl ether and sorbitol polyglycidyl ether; a polyaldehyde compound such as glyoxal and terephthalaldehyde; a polyisocyanate compound such as tolylene diisocyanate, hexamethylene diisocyanate, diphenylmethane isocyanate, xylylene diisocyanate, polymethylene polyphenyl isocyanate, cyclohexyl diisocyanate, cyclohexane phenylene diisocyanate, naphthalene-1,5-diisocyanate, isopropylbenzene-2,4-diisocyanate and polypropylene glycol/tolylene diisocyanate addition reaction product; a block polyisocyanate compound; a silane coupling agent such as tetraalkoxysilane; a metal crosslinking agent such as acetylacetonate of aluminum, copper or iron(III); and a polymethylol compound such as trimethylolmelamine and pentaerythritol. Out of these thermal crosslinking agents, a water-soluble crosslinking agent is preferred because a coating solution can be easily prepared and the reduction in the hydrophilicity of the produced hydrophilic layer can be prevented.

As regards the catalyst, initiator and crosslinking agent for use in the hydrophilic composition, the amount added is described below. The amount of the catalyst added is not particularly limited but is preferably adjusted to a value in the range of 0.1 to 20 parts by mass per 100 parts by mass of the specific hydrophilic polymer (A). When the amount of the catalyst added is 0.1 parts by mass or more, curability is not decreased and a sufficient curing rate can be obtained. Also, when the amount of the catalyst added is 20 parts by mass or less, the obtained cured product can have sufficient hydrophilicity. In view of good balance between the curability and the hydrophilicity of the obtained cured product, the amount of the catalyst added is more preferably adjusted to a value in the range of 1 to 20 parts by mass per 100 parts by mass of the specific hydrophilic polymer (A).

### (1) Inorganic Fine Particle

The hydrophilic composition of the present invention may contain an inorganic fine particle for the purpose of enhancing the hydrophilicity or increasing the film strength.

Suitable examples of the inorganic fine particle include silica, alumina, magnesium oxide, titanium oxide, magnesium carbonate, calcium alginate, and a mixture thereof.

The inorganic fine particle preferably has an average particle diameter of 2 nm to 1 μm, more preferably from 0.10 to 1100 nm. Within this range, the particle is stably dispersed in the hydrophilic film, obtained through coating and drying and maintains sufficient strength of the hydrophilic film, so that a film with high durability and excellent hydrophilicity can be formed.

Out of the inorganic particles above, a colloidal silica dispersion is particularly preferred and this can be easily available as a commercial product.

The content of the inorganic fine particle is appropriately selected according to the purpose but is preferably 80 mass % or less, more preferably 50 mass % or less, based on the entire solid content of the composition.

### (2) Surfactant

In the hydrophilic composition of the present invention, a surfactant may be added.

The surfactant includes those described in JP-A-62-173463 and JP-A-62-183457. Examples thereof include an anionic surfactant such as dialkylsulfosuccinates, alkylnaphthalenesulfonates and fatty acid salts; a nonionic surfactant such as polyoxyethylene alkyl ethers, polyoxyethylene alkyl allyl ethers, acetylene glycols and polyoxyethylene•polyoxypropylene block copolymers; and a cationic surfactant such as alkylamine salts and quaternary ammonium salts. Here, an organic fluoro compound may be used in place of the surfactant. The organic fluoro compound is preferably hydrophobic. The organic fluoro compound includes, for example, a fluorine-containing surfactant, an oily fluorine-based compound (e.g., fluorine oil) and a solid fluorine compound resin (e.g., ethylene tetrafluoride resin), and examples thereof include those described in JP-B-57-9053 (columns 8 to 17) and JP-A-62-135826.

### (3) Ultraviolet Absorber

In the present invention, from the standpoint of enhancing the weather resistance and durability of the hydrophilic film formed from the hydrophilic composition, an ultraviolet absorber can be used.

Examples of the ultraviolet absorber include benzotriazole-based compounds described in JP-A-58-185677, JP-A-61-190537, JP-A-2-782, JP-A-5-197075 and JP-A-9-34057, benzophenone-based compounds described in JP-A-46-2784, JP-A-5-194483 and U.S. Pat. No. 3,214,463, cinnamic acid-based compounds described in JP-B-48-30492, JP-B-56-21141 and JP-A-10-88106, triazine-based compounds described in JP-A-4-298503, JP-A-8-53427, JP-A-8-239368, JP-A-10-182621 and JP-T-8-501291 (the term “JP-T” as used herein means a “published Japanese translation of a PCT patent application”), compounds described in Research Disclosure, No. 24239, and compounds capable of absorbing ultraviolet light and emitting fluorescent light, so-called fluorescent brightening agents, as typified by stilbene-based compounds and benzoxazole-based compounds.

The amount of the ultraviolet absorber added is appropriately selected according to the purpose but in general, is preferably from 0.5 to 15 mass % in terms of the solid content.

### (4) Antioxidant

An antioxidant may be added for enhancing the stability of the hydrophilic film formed from the hydrophilic composition of the present invention. Examples of the antioxidant include those described in EP-A-223739, EP-A-309401, EP-A-309402, EP-A-310551, EP-A-310552, EP-A-459416, DE-A-3435443, JP-A-5448535, JP-A-62-262047, JP-A-63-113536, JP-A-63-163351, JP-A-2-262654, JP-A-2-71262, JP-A-3-121449, JP-A-5-61166, JP-A-5-119449, and U.S. Pat. Nos. 4,814,262 and 4,980,275.

The amount of the antioxidant added is appropriately selected according to the purpose but is preferably from 0.1 to 8 mass % in terms of the solid content.

### (5) Solvent

For ensuring the formation of a uniform coating film on a substrate at the time of forming a hydrophilic film from the hydrophilic composition of the present invention, it is also effective to appropriately add an organic solvent to the coating solution for forming a hydrophilic layer.

Examples of the solvent include a ketone-based solvent such as acetone, methyl ethyl ketone and diethyl ketone, an alcohol-based solvent such as methanol, ethanol, 2-propanol, 1-propanol, 1-butanol and tert-butanol, a chlorine-based solvent such as chloroform and methylene chloride, an aromatic solvent such as benzene and toluene, an ester-based solvent such as ethyl acetate, butyl acetate and isopropyl acetate, an ether-based solvent such as diethyl ether, tetrahydrofuran and dioxane, and a glycol ether-based solvent such as ethylene glycol monomethyl ether and ethylene glycol dimethyl ether.

In this case, addition of a solvent in a range not causing a problem in relation to VOC (volatile organic compounds) is effective, and the amount thereof is preferably from 0 to 50 mass %, more preferably from 0 to 30 mass %, based on the entire coating solution when forming a hydrophilic film.

### (6) Polymer Compound

In the hydrophilic composition of the present invention, for adjusting the film properties of the hydrophilic layer, various polymer compounds may be added within the range not inhibiting the hydrophilicity. Examples of the polymer compound which can be used include an acrylic polymer, a polyvinylbutyral resin, a polyurethane resin, a polyamide resin, a polyester resin, an epoxy resin, a phenol resin, a polycarbonate resin, a polyvinylbutyral resin, a polyvinylformal resin, shellac, a vinyl-based resin, an acrylic resin, a rubber-based resin, waxes, and other natural resins. Two or more of these may be used in combination. Above all, a vinyl-based copolymer obtained by the copolymerization of an acrylic monomer is preferred. Furthermore there may also be preferably used a copolymer where a “carboxyl group-containing monomer”, an “alkyl methacrylate” or an “alkyl acrylate” is contained, as a structural unit having a linking group as for the copolymerization composition of a polymer compound.

In addition, for example, a leveling additive, a matting agent, waxes for adjusting the film properties, and a tackifier for improving the adherence to a substrate may be contained, if desired, in the range not inhibiting the hydrophilicity.

Specific examples of the tackifier include adhesive polymers having a high molecular weight described in JP-A-2001-49200, pages 5 and 6 (for example, a copolymerization product comprising an ester of a (meth)acrylic acid and an alcohol containing an alkyl group having a carbon number of 1 to 20, an ester of a (meth)acrylic acid and an alicyclic alcohol having a carbon number of 3 to 34, and an ester of a (meth)acrylic acid and an aromatic alcohol having a carbon number of 6 to 14), and a low molecular weight tackifier resin having a polymerizable unsaturated bond.

Other than these components, within the range not impairing the purpose of the present invention or curing, the hydrophilic composition may further contain additives such as radical polymerization initiator, photo sensitizer, polymerization inhibitor, polymerization initiation aid, wettability improver, plasticizer, antistatic agent, silane coupling agent, antiseptic, pigment, drier, anti-settling agent anti-sagging agent, thickener, anti-skinning agent, anti-floating/anti-flooding agent, leveling agent, defoaming agent, anti-adhesive agent, matting agent, flame retardant and rust inhibitor.

The amount added is appropriately selected according to the purpose but in general, is preferably from 0.5 to 15 mass % in terms of the solid content.

### (Substrate)

As regards the substrate usable as a support for the hydrophilic composition of the present invention, for example, in the case of a transparent substrate expected to exert antifouling and/or antifogging effects, an inorganic substrate such as, in terms of the material, glass or inorganic compound layer-containing glass, or a substrate capable of transmitting visible light, such as inorganic compound layer-containing transparent plastic layer, may be suitably utilized.

Also, in the case of applying the antifouling and/or antifogging member to a substrate requiring no transparency, for example, metal, alloy, ceramic, wood, stone, cement, concrete, fiber, cloth, and a combination or laminate thereof all may be suitably utilized as the support substrate, in addition to the above-described transparent substrate.

### (Treating Method of Substrate)

In coating the composition on a substrate, the hydrophilic film can be coated directly on an untreated substrate or, if desired, one surface or both surfaces of the substrate may be subjected to a surface hydrophilizing treatment for the purpose of enhancing the adherence of the hydrophilic film. Examples of the surface hydrophilizing treatment include a corona discharge treatment, a glow discharge treatment, a chromic acid treatment (wet), a flame treatment, a hot air treatment, an ozone/ultraviolet irradiation treatment, an alkali treatment, sandblasting and brush polishing.

### (Undercoat Layer)

Furthermore, one or more undercoat layers can be provided. As for the material of the undercoat layer, an inorganic film such as metal oxide film or an organic film may be used. Also, in the case of using a substrate susceptible to oxidation, such as metal, it is preferred to provide various anti-rust layers such as chromate treatment.

Examples of the metal oxide film include SiO₂, Al₂O₃, ZrO₂ and TiO₂, and the metal oxide film can be formed by a sol-gel method, a sputtering method or a vapor deposition method.

Examples of the material for the organic film include a solvent-type adhesive of chloroprene, NBR, SBR or acryl, an emulsion-type adhesive of vinyl acetate, vinyl acetate/acryl copolymer, EVA, acryl, urethane or chloroprene, a hot-melt type of EVA, olefin, polyamide, polyester, SIS, SBS or SEBS, an ambient temperature or moisture-curing type of urethane, silicon or acrylsilicon, an ambient temperature-curing type of epoxy, acryl, urethane or acrylsilicon, a heat curing type of epoxy, urea, melamine, phenol or acrylsilicon, and a UV curing type of acryl.

As regards each of these materials for the organic film, one kind may be used alone or two or more kinds may be used in combination. Also, a hydrophilic resin and a water-dispersible latex may be used in combination.

A crosslinking agent capable of crosslinking the above-described hydrophilic resin or water-dispersible latex may also be used.

As for the crosslinking agent applicable to the present inventions a known crosslinking agent that forms crosslinking under heat may be used. The thermal crosslinking agent in general includes those described in Shinzo Yamashita and Tosuke Kaneko, Kakyozai Handbook (Crosslinking Agent Handbook), Taiseisha (1981). The crosslinking agent for use in the present invention is not particularly limited as long as it has two or more functional groups and can effectively crosslink with the hydrophilic resin or water-dispersible latex. Specific examples of the thermal crosslinking agent include a polycarboxylic acid such as polyacrylic acid; an amine compound such as diamine and polyethyleneimine; a polyepoxy compound such as ethylene or propylene glycol diglycidyl ether, tetraethylene glycol diglycidyl ether, nonaethylene glycol diglycidyl ether, polyethylene or polypropylene glycol glycidyl ether, neopentyl glycol diglycidyl ether, 1,6-hexanediol diglycidyl ether, trimethylolpropane triglycidyl ether and sorbitol polyglycidyl ether; a polyaldehyde compound such as glyoxal and terephthalaldehyde; a polyisocyanate compound such as tolylene diisocyanate, hexamethylene diisocyanate, diphenylmethane isocyanate, xylylene diisocyanate, polymethylene polyphenyl isocyanate, cyclohexyl diisocyanate, cyclohexane phenylene diisocyanate, naphthalene-1,5-diisocyanate, isopropylbenzene-2,4-diisocyanate and polypropylene glycol/tolylene diisocyanate addition reaction product; a block polyisocyanate compound; a silane coupling agent such as tetraalkoxysilane; a metal crosslinking agent such as acetylacetonate of aluminum, copper or iron(III); and a polymethylol compound such as trimethylolmelamine and pentaerythritol. Out of these thermal crosslinking agents, a water-soluble crosslinking agent is preferred because a coating solution can be easily prepared and the reduction in the hydrophilicity of the produced hydrophilic layer can be prevented.

The total amount of the hydrophilic resin and/or water-dispersible latex in the undercoat layer is preferably from 0.01 to 201, more preferably from 0.05 to 10 μm.

### (Coating Method)

The method for coating the hydrophilic composition on a substrate is not particularly limited, but there may be applied a known method, for example, a coating method such as bar coating method, dip coating method, spin coating method, flow coating method, spray coating method, roll coating method and gravure coating method, a coating method using a sponge, and a vapor phase method including a physical vapor deposition (PVD) method and a chemical vapor deposition (CVD) method, such as vacuum vapor deposition method, reactive vapor deposition method, ion beam assist method, sputtering method and ion plating method. Among these, the coating method is preferably any one of a spray coating method, a spin coating method, a dip coating method, a roll coating method, a flow coating method, a bar coating method and a coating method using a sponge.

### (Preparation of Hydrophilic Composition)

The hydrophilic composition can be prepared by dissolving a specific hydrophilic polymer (A), a W/O/W emulsion (B) and preferably a catalyst or an initiator (C) in a solvent such as ethanol and stirring the solution. The reaction temperature is from room temperature to 80° C., and the reaction time, that is, the time for which stirring is continued, is preferably from 1 to 72 hours.

The hydrophilic treated member of the present invention can be obtained by coating a solution containing the hydrophilic composition of the present invention on an appropriate substrate and drying the coating. That is, the hydrophilic member of the invention has a hydrophilic film formed by coating the hydrophilic composition of the present invention on a substrate and drying the coating under heating.

In the formation of the hydrophilic film, from the standpoint of efficiently forming a high-density crosslinked structure, the drying under heating after coating a solution containing the hydrophilic composition is preferably performed under the conditions of a temperature of 50 to 200° C. and a drying time of approximately from 2 minutes to one hour, more preferably a temperature of 80 to 160° C. and a drying time of 5 to 30 minutes. As for the heating means, a known device such as dryer having a temperature-adjusting function is preferably employed.

Also, as regards the hydrophilic member of the present invention, in the case of coating a hydrophilic layer and an undercoat layer on a substrate, a catalyst may be mixed immediately before coating the hydrophilic layer on the substrate. More specifically, the coating solution is preferably coated within one hour after mixing the catalyst. If the coating solution after mixing the catalyst is left standing for a long time and then coated, the viscosity of the hydrophilic composition increases and a defect such as uneven coating may be caused. Other components are also preferably mixed immediately before coating, but this coating solution may be stored for a long time after mixing.

### (Layer Construction in Use of Hydrophilic Member)

In the case of using the hydrophilic member of the present invention with expectation to bring out antifouling and/or antifogging effects, a separate layer may be appropriately added according to the purpose, mode and place in use. The construction of layers added, if desired, is described below.

### 1) Adhesive Layer

In the case of using the hydrophilic member of the present invention by laminating it to another substrate, an adhesive that is a pressure-sensitive adhesive is preferably used as an adhesive layer on the back surface of the substrate. As for the adhesive, those generally used for a self-adhesive sheet, such as rubber-based adhesive, acryl-based adhesive, silicone-based adhesive, vinyl ether-based adhesive and styrene-based adhesive, may be used.

In the case where optical transparency is required, an adhesive for optical usage is selected. In the case where a pattern such as coloration, translucence or mat texture is required, in addition to the texturing of the substrate, a dye or an organic or inorganic fine particle may be added to the adhesive to bring out the effect.

In the case where a tackifier is required, one kind of a resin, for example, a tackifier resin such as rosin-based resin, terpene-based resin, petroleum-based resin, styrene-based resin and hydrogenation product thereof, may be used, or some of these may be used as a mixture.

The adhesive force of the adhesive for use in the present invention is an adhesive force generally called strong adhesion and is 200 g/25 nm or more, preferably 300 g/25 mm or more, more preferably 400 g/25 ml or more. The adhesive force as used herein is a value measured by a 180° C. peeling test according to JIS Z 0237.

### 2) Release Layer

In the case where the hydrophilic member of the present invention has the above-described adhesive layer, a release layer may be further added. In the release layer, a release agent is preferably incorporated so as to impart releasability. Examples of the release agent which can be generally used include a silicone-based release agent comprising polyorganosiloxane, a fluorine-based compound, a long chain alkyl-modified polyvinyl alcohol, and a long chain alkyl-modified polyethyleneimine. Also, there may be used various release agents such as hot-melt release agent and monomer-type release agent in which a releasing monomer is cured by radical polymerization, cationic polymerization, polycondensation reaction or the like; a copolymer-based resin such as acryl-silicone-based copolymer resin, acryl-fluorine-based copolymer resin and urethane-silicone-fluorine-based copolymer resin; a resin blend of silicone-based resin and acryl-based resin; and a resin blend of fluorine-based resin and acryl-based resin. Furthermore, a hardcoat release layer may be formed by curing a curable composition containing either one atom of fluorine atom and/or silicon atom and an active energy ray-polymerizable group-containing compound.

### 3) Other Layers

A protective layer may be provided on the hydrophilic layer. The protective layer has a function of preventing scratching on the hydrophilic surface during handling, transportation or storage or preventing reduction in the hydrophilicity due to attachment of a contaminant. As for the protective layer, a hydrophilic polymer layer used for the above-descried release layer may be used. The protective layer is stripped off after laminating the hydrophilic member to an appropriate substrate.

### (Form of Structure)

The hydrophilic treated member of the present invention may be supplied in the form of a sheet, a roll or a ribbon or may be previously cut into a size suitable for the lamination to an appropriate substrate and then supplied.

In the case of applying (using or laminating) the hydrophilic member having provided thereon the hydrophilic coat of the present invention to windowpane or the like, transparency is important from the standpoint of securing visibility. The hydrophilic coat of the present invention has excellent transparency, and the transparency is not impaired even when the thickness is large, so that both transparency and durability can be satisfied. The thickness of the hydrophilic coat is preferably from 0.01 to 100 μm, more preferably from 0.05 to 5 μm, and most preferably from 0.1 to 20 μm. When the film thickness is 0.01 pin or more, sufficiently high hydrophilicity and durability are advantageously obtained, and when the film thickness is 100 μm or less, a problem in terms of film-forming property, such as cracking, does not arise and this is preferred.

The transparency is evaluated by measuring the light transmittance in the visible light region (400 to 800 nm) by a spectrophotometer. The light transmittance is preferably from 100 to 70%, more preferably from 95 to 75%, and most preferably from 95 to 80%. By virtue of light transmittance in this range, the hydrophilic member having provided thereon the hydrophilic coat can be applied to various uses without hindering the visibility.

### EXAMPLES

The present invention is described in detail below by referring to Examples, but the present invention is not limited thereto.

A float sheet glass (thickness-2 mm) that is a most common transparent sheet glass was provided and the surface of the sheet glass was hydrophilized by a UV/O treatment for 10 minutes to produce a substrate for coating. A coating solution having a composition shown in Tables 1 to 6 was stirred at 25° C. for 2 hours, coated by a coating bar on the substrate for coating and then dried at 150° C. for 30 minutes to form a hydrophilic film having a dry thickness of 3.0 μm.

The preparation methods or suppliers of the components shown in Tables 1 to 6 are described below.

### (Synthesis of Hydrophilic Polymer (1))

Into a 500 ml-volume three-neck flask, 11.9 g of acrylamide, 11.6 g of acrylamide-3-(ethoxysilyl)propyl and 280 g of 1-methoxy-2-propanol were charged and 1.9 g of dimethyl 2,2′-azobis(2-methylpropionate) was added thereto at 80° C. in a nitrogen stream. The mixture was kept at the same temperature with stirring for 6 hours and then cooled to room temperature. The resulting reaction solution was poured in 2 liter of acetone, and the precipitated solid was collected by filtration. The obtained solid was washed with acetone to obtain Hydrophilic Polymer (1). The mass after drying was 22.1 g. The mass average molecular weight of the polymer as determined by GPC (polyethylene oxide standard) was 23,000.

In the following, hydrophilic polymers used in Examples were synthesized by the same method as above and subjected to evaluation. Structures of Hydrophilic Polymers (1) and (2) used in Examples are shown below.

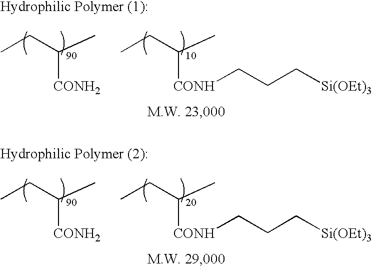

### (Catalyst Solution (1))

This catalyst solution was prepared by mixing 200 g of ethanol and 10 g of acetylacetone, adding 10 g of tetraethyl ortho-titanate, stirring the mixture for 10 minutes, then adding 100 g of purified water and further stirring the mixture for one hour.

### (W/O/W Emulsion (1))

Polyethylene glycol 200 (produced by Wako Pure Chemical Industries, Ltd., MW: 200) (0.8 g) was dissolved in 0.8 g of distilled water. The obtained solution was added to a solution prepared by dissolving 5.4 g of Takenate D110N (produced by Takeda Chemical Industries, Ltd., a 75% ethyl acetate solution) and 0.17 g of SPAN80 (produced by Wako Pure Chemical Industries, Ltd.) in 15.3 g of ethyl acetate, and the solutions were mixed in a homogenizer for 10 minutes to obtain a W/O emulsion. This W/O emulsion was poured in 200 ml of 0.5% polyvinyl alcohol (produced by Wako Pure Chemical Industries, Ltd.), and the solutions were mixed in a homogenizer at 500 rpm for 30 minutes and further mixed at 40° C. for 2 hours to obtain a W/O/W emulsion having a particle diameter of about 0.5 μm. In this W/O/W Emulsion (1), the wall material is urea resin and the inner aqueous phase is polyethylene glycol.

### (W/O/W Emulsion (2))

This emulsion was prepared in the same manner as W/O/W Emulsion (1) except for changing polyethylene glycol 200 to polyethylene glycol 400 (produced by Wako Pure Chemical Industries, Ltd., MW: 400). The particle diameter of W/O/W Emulsion (2) is about 0.5 pin. In this W/O/W Emulsion (2), the wall material is urea resin and the inner aqueous phase is polyethylene glycol.

### (W/O/W Emulsion (3))

This emulsion was prepared in the same manner as W/O/W Emulsion (1) except for changing polyethylene glycol 200 to polyacrylamide (produced by Wako Pure Chemical Industries, Ltd., MW: 10,000). The particle diameter of W/O/W Emulsion (3) is about 0.5 pin. In this W/O/W Emulsion (3), the wall material is urea resin and the inner aqueous phase is acrylamide.

### (W/O/W Emulsion (4))

This emulsion was prepared in the same manner as W/O/W Emulsion (1) except for changing polyvinyl alcohol to R-1130 (produced by Kuraray Co., Ltd.). The particle diameter of W/O/W Emulsion (4) is about 0.5 μm. In this W/O/W Emulsion (4), the wall material is urea resin, the inner aqueous phase is polyethylene glycol, and the surface has a crosslinking group.

### (W/O/W Emulsion (5))

Polyethylene glycol 200 (produced by Wako. Pure Chemical Industries, Ltd., MW: 200) (0.8 g) was dissolved in 0.8 g of distilled water. The obtained solution was added to a solution prepared by dissolving 54 g of trimethylolpropane methacrylate (produced by Wako Pure Chemical Industries, Ltd.), 6 mg of V-65 (produced by Wako Pure Chemical Industries, Ltd., 2,2-azobis(2,4-dimethylvaleronitrile)) and 0.34 g of SPAN80 (produced by Wako Pure Chemical Industries, Ltd.) in 50 g of methylene chloride, and the solutions were mixed in a homogenizer for 10 minutes to obtain a W/O emulsion. This W/O emulsion was poured in 400 ml of 0.5% polyvinyl alcohol (produced by Wako Pure Chemical Industries, Ltd.), and the solutions were mixed in a homogenizer at 200 rpm for 30 minutes and further mixed at 55° C. for 2 hours in a nitrogen atmosphere to obtain a W/O/W emulsion having a particle diameter of about 1 μm. In this W/O/W Emulsion (5), the wall material is acrylic resin and the inner aqueous phase is polyethylene glycol.

### (W/O/W Emulsion (6))

This emulsion was prepared in the same manner as W/O/W Emulsion (5) except for adding vinyltrimethoxysilane (produced by Wako Pure Chemical Industries, Ltd.) to trimethylolpropane methacrylate. The particle diameter of W/O/W Emulsion (6) is about 1 μm. In this W/O/W Emulsion (6), the wall material is urea resin the inner aqueous phase is polyethylene glycol, and the surface has a crosslinking group.

### (Surfactant)

A 5 mass % aqueous solution of anionic surfactant having a structural formula shown below was used.

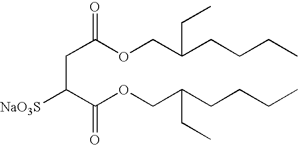

### (Preparation of Coating Solution)

### Examples 1 to 4

Coating solutions were prepared by the following procedure to have a solid content concentration (mass %) shown in Table 1.

W/O/W Emulsion (1) and Hydrophilic Polymer (1) were dissolved in distilled water and after adding Catalyst Solution (1), the resulting solution was stirred at room temperature for 2 hours. Then, a surfactant was added thereto to prepare a coating solution.

### Examples 5 to 8

Coating solutions were prepared by the same procedure as in Examples 1 to 4 except for changing W/O/W Emulsion (1) to W/O/W Emulsion (2).

### Examples 9 to 12

Coating solutions were prepared by the same procedure as in Examples 1 to 4 except for changing W/O/W Emulsion (1) to W/O/W Emulsion (3).

### Examples 13 to 16

Coating solutions were prepared by the same procedure as in Examples 1 to 4 except for changing W/O/W Emulsion (1) to W/O/W Emulsion (4).

### Examples 17 to 20

Coating solutions were prepared by the same procedure as in Examples 1 to 4 except for changing W/O/W Emulsion (1) to W/O/W Emulsion (5).

### Examples 21 to 24

Coating solutions were prepared by the same procedure as in Examples 1 to 4 except for changing W/O/W Emulsion (1) to W/O/W Emulsion (6).

### Examples 25 to 48

Coating solutions were prepared by the same procedure as in Examples 1 to 24 except for changing Hydrophilic Polymer (1) to Hydrophilic Polymer (2).

TABLE 1

| | Example | | | | | | | |
|---|---|---|---|---|---|---|---|---|
| | 1 | 2 | 3 | 4 | 5 | 6 | 7 | 8 |
| Hydrophilic Polymer (1) | 45 | 35 | 25 | 15 | 45 | 35 | 25 | 15 |
| Hydrophilic Polymer (2) | — | — | — | — | — | — | — | — |
| W/O/W Emulsion (1) | 5 | 15 | 25 | 35 | — | — | — | — |
| W/O/W Emulsion (2) | — | — | — | — | 5 | 15 | 25 | 35 |
| W/O/W Emulsion (3) | — | — | — | — | — | — | — | — |
| W/O/W Emulsion (4) | — | — | — | — | — | — | — | — |
| W/O/W Emulsion (5) | — | — | — | — | — | — | — | — |
| W/O/W Emulsion (6) | — | — | — | — | — | — | — | — |
| Catalyst (1) | 1 | 1 | 1 | 1 | 1 | 1 | 1 | 1 |
| Surfactant | 0.5 | 0.5 | 0.5 | 0.5 | 0.5 | 0.5 | 0.5 | 0.5 |

TABLE 2

| | Example | | | | | | | |
|---|---|---|---|---|---|---|---|---|
| | 9 | 10 | 11 | 12 | 13 | 14 | 15 | 16 |
| Hydrophilic Polymer (1) | 45 | 35 | 25 | 15 | 45 | 35 | 25 | 15 |
| Hydrophilic Polymer (2) | — | — | — | — | — | — | — | — |
| W/O/W Emulsion (1) | — | — | — | — | — | — | — | — |
| W/O/W Emulsion (2) | — | — | — | — | — | — | — | — |
| W/O/W Emulsion (3) | 5 | 15 | 25 | 35 | — | — | — | — |
| W/O/W Emulsion (4) | — | — | — | — | 5 | 15 | 25 | 35 |
| W/O/W Emulsion (5) | — | — | — | — | — | — | — | — |
| W/O/W Emulsion (6) | — | — | — | — | — | — | — | — |
| Catalyst (1) | 1 | 1 | 1 | 1 | 1 | 1 | 1 | 1 |
| Surfactant | 0.5 | 0.5 | 0.5 | 0.5 | 0.5 | 0.5 | 0.5 | 0.5 |

TABLE 3

| | Example | | | | | | | |
|---|---|---|---|---|---|---|---|---|
| | 17 | 18 | 19 | 20 | 21 | 22 | 23 | 24 |
| Hydrophilic Polymer (1) | 45 | 35 | 25 | 15 | 45 | 35 | 25 | 15 |
| Hydrophilic Polymer (2) | — | — | — | — | — | — | — | — |
| W/O/W Emulsion (1) | — | — | — | — | — | — | — | — |
| W/O/W Emulsion (2) | — | — | — | — | — | — | — | — |
| W/O/W Emulsion (3) | — | — | — | — | — | — | — | — |
| W/O/W Emulsion (4) | — | — | — | — | — | — | — | — |
| W/O/W Emulsion (5) | 5 | 15 | 25 | 35 | — | — | — | — |
| W/O/W Emulsion (6) | — | — | — | — | 5 | 15 | 25 | 35 |
| Catalyst (1) | 1 | 1 | 1 | 1 | 1 | 1 | 1 | 1 |
| Surfactant | 0.5 | 0.5 | 0.5 | 0.5 | 0.5 | 0.5 | 0.5 | 0.5 |

TABLE 4

| | Example | | | | | | | |
|---|---|---|---|---|---|---|---|---|
| | 25 | 26 | 27 | 28 | 29 | 30 | 31 | 32 |
| Hydrophilic Polymer (1) | — | — | — | — | — | — | — | — |
| Hydrophilic Polymer (2) | 45 | 35 | 25 | 15 | 45 | 35 | 25 | 15 |
| W/O/W Emulsion (1) | 5 | 15 | 25 | 35 | — | — | — | — |
| W/O/W Emulsion (2) | — | — | — | — | 5 | 15 | 25 | 35 |
| W/O/W Emulsion (3) | — | — | — | — | — | — | — | — |
| W/O/W Emulsion (4) | — | — | — | — | — | — | — | — |
| W/O/W Emulsion (5) | — | — | — | — | — | — | — | — |
| W/O/W Emulsion (6) | — | — | — | — | — | — | — | — |
| Catalyst (1) | 1 | 1 | 1 | 1 | 1 | 1 | 1 | 1 |
| Surfactant | 0.5 | 0.5 | 0.5 | 0.5 | 0.5 | 0.5 | 0.5 | 0.5 |

TABLE 5

| | Example | | | | | | | |
|---|---|---|---|---|---|---|---|---|
| | 33 | 34 | 35 | 36 | 37 | 38 | 39 | 40 |
| Hydrophilic Polymer (1) | — | — | — | — | — | — | — | — |
| Hydrophilic Polymer (2) | 45 | 35 | 25 | 15 | 45 | 35 | 25 | 15 |
| W/O/W Emulsion (1) | — | — | — | — | — | — | — | — |
| W/O/W Emulsion (2) | — | — | — | — | — | — | — | — |
| W/O/W Emulsion (3) | 5 | 15 | 25 | 35 | — | — | — | — |
| W/O/W Emulsion (4) | — | — | — | — | 5 | 15 | 25 | 35 |
| W/O/W Emulsion (5) | — | — | — | — | — | — | — | — |
| W/O/W Emulsion (6) | — | — | — | — | — | — | — | — |
| Catalyst (1) | 1 | 1 | 1 | 1 | 1 | 1 | 1 | 1 |
| Surfactant | 0.5 | 0.5 | 0.5 | 0.5 | 0.5 | 0.5 | 0.5 | 0.5 |

TABLE 6

| | Example | | | | | | | |
|---|---|---|---|---|---|---|---|---|
| | 41 | 42 | 43 | 44 | 45 | 46 | 47 | 48 |
| Hydrophilic Polymer (1) | — | — | — | — | — | — | — | — |
| Hydrophilic Polymer (2) | 45 | 35 | 25 | 15 | 45 | 35 | 25 | 15 |
| W/O/W Emulsion (1) | — | — | — | — | — | — | — | — |
| W/O/W Emulsion (2) | — | — | — | — | — | — | — | — |
| W/O/W Emulsion (3) | — | — | — | — | — | — | — | — |
| W/O/W Emulsion (4) | — | — | — | — | — | — | — | — |
| W/O/W Emulsion (5) | 5 | 15 | 25 | 35 | — | — | — | — |
| W/O/W Emulsion (6) | — | — | — | — | 5 | 15 | 25 | 35 |
| Catalyst (1) | 1 | 1 | 1 | 1 | 1 | 1 | 1 | 1 |
| Surfactant | 0.5 | 0.5 | 0.5 | 0.5 | 0.5 | 0.5 | 0.5 | 0.5 |

### Comparative Examples 1 to 8

A float sheet glass (thickness: 2 mm) that is a most common transparent sheet glass was provided, and the surface of the sheet glass was hydrophilized by a UV/03 treatment for 10 minutes to produce a substrate for coating. A coating solution prepared by dissolving respective components shown in Table 2 to have a composition (parts by mass) shown in Table 7 was stirred at 25° C. for 2 hours, coated by a coating bar on the substrate for coating and then dried at 150° C. for 30 minutes to form a hydrophilic film having a dry thickness of 3.0 μm.

TABLE 7

| | Comparative Example | | | | | | | |
|---|---|---|---|---|---|---|---|---|
| | 1 | 2 | 3 | 4 | 5 | 6 | 7 | 8 |
| Hydrophilic Polymer (1) | 50 | — | — | — | — | — | — | — |
| Hydrophilic Polymer (2) | — | 50 | — | — | — | — | — | — |
| Comparative hydrophilic | — | — | — | — | 35 | 15 | — | — |
| polymer (1) | | | | | | | | |
| Comparative hydrophilic | — | — | — | — | — | — | 35 | 15 |
| polymer (2) | | | | | | | | |
| Comparative hydrophilic | — | — | 35 | 15 | — | — | — | — |
| polymer (3) | | | | | | | | |
| W/O/W Emulsion (1) | — | — | 15 | 35 | 15 | 35 | 15 | 35 |
| Catalyst (1) | 1 | 1 | 1 | 1 | 1 | 1 | 1 | 1 |
| Surfactant | 0.5 | 0.5 | 0.5 | 0.5 | 0.5 | 0.5 | 0.5 | 0.5 |

### (Comparative Hydrophilic Polymer (1))

Polyamide (produced by Wako Pure Chemical Industries, Ltd., MW: from 5,000,000 to 6,000,000) was used.

### (Comparative Hydrophilic Polymer (2))

Polyvinyl alcohol (produced by Wako Pure Chemical Industries, Ltd., MW: 22,000) was used.

### (Comparative Hydrophilic Polymer (3))

A partial hydrolysis condensate of tetramethoxysilane (produced by Wako Pure Chemical Industries, Ltd.) was used.

In Comparative Examples, the components used other than Comparative Hydrophilic Polymers (1) to (3) are as follows.

### Hydrophilic Polymer (1):

The same Hydrophilic Polymer (1) as in Examples.

### Hydrophilic Polymer (2):

The same Hydrophilic Polymer (2) as in Examples.

### Catalyst Solution (1):

The same catalyst solution as in Examples,

### Surfactant:

The same surfactant as in Examples.

### (Evaluation of Hydrophilic Member)

### (Hydrophilicity)

The water drop-in-air contact angle (θ) was measured (measured by Drop Master 500 manufactured by Kyowa Interface Science Co., Ltd.) and rated as follows.

A: θ≦15°

B: 15°<θ

### (Bending Resistance)

The coating solution was coated on an aluminum sheet to have a coating film thickness of 0.3 mm and dried at 150° C. for 30 minutes. This sample was subjected to a test in accordance with JIS K5600-5-1 and the presence or absence of cracking was evaluated. A mandrel having a diameter of 2 mm was used.

(Hydrophilicity and Scratch Resistance Evaluation after Dry Rubbing)

### Abrasion Test:

The coating film was rubbed with a nonwoven fabric (BEMCOT, produced by Asahi Kasei Fibers Corp.) 2,000 times under a load of 500 g. The contact angle (θ) was rated and scratching was evaluated with an eye.

### Contact Angle (θ):

A: θ≦15°

B: 15°<θ

### Scratching:

A: No scratch

B: 5 or less linear scratches

C: More than 5 scratches

(Hydrophilicity and Scratch Resistance Evaluation after Wet Rubbing)

### Abrasion Test:

The coating film was rubbed with a water-impregnated nonwoven fabric (BEMCOT, produced by Asahi Kasei Fibers Corp.) 1,000 times under a load of 500 g. The contact angle (θ) was rated and scratching was evaluated with an eye,

### Contact Angle (θ):

A: θ≦15°

B: 15°<θ

### Scratching:

A: No scratch

B: 5 or less linear scratches

C: More than 5 scratches

The evaluation results according to the evaluation methods above are shown in Tables 8 to 14.

TABLE 8

| | Example | | | | | | | |
|---|---|---|---|---|---|---|---|---|
| | 1 | 2 | 3 | 4 | 5 | 6 | 7 | 8 |
| Hydrophilicity | A | A | A | A | A | A | A | A |
| Bending resistance | NP | NP | NP | NP | NP | NP | NP | NP |
| Dry rubbing (scratch resistance) | B | B | B | B | B | B | B | B |
| Dry rubbing (hydrophilicity) | A | A | A | A | A | A | A | A |
| Wet rubbing (scratch resistance) | B | B | B | B | B | B | B | B |
| Wet rubbing (hydrophilicity) | A | A | A | A | A | A | A | A |

NP: no problem

TABLE 9

| | Example | | | | | | | |
|---|---|---|---|---|---|---|---|---|
| | 9 | 10 | 11 | 12 | 13 | 14 | 15 | 16 |
| Hydrophilicity | A | A | A | A | A | A | A | A |
| Bending resistance | NP | NP | NP | NP | NP | NP | NP | NP |
| Dry rubbing (scratch resistance) | B | B | B | B | A | A | A | A |
| Dry rubbing (hydrophilicity) | A | A | A | A | A | A | A | A |
| Wet rubbing (scratch resistance) | B | B | B | B | A | A | A | A |
| Wet rubbing (hydrophilicity) | A | A | A | A | A | A | A | A |

NP: no problem

TABLE 10

| | Example | | | | | | | |
|---|---|---|---|---|---|---|---|---|
| | 17 | 18 | 19 | 20 | 21 | 22 | 23 | 24 |
| Hydrophilicity | A | A | A | A | A | A | A | A |
| Bending resistance | NP | NP | NP | NP | NP | NP | NP | NP |
| Dry rubbing (scratch resistance) | B | B | B | B | A | A | A | A |
| Dry rubbing (hydrophilicity) | A | A | A | A | A | A | A | A |
| Wet rubbing (scratch resistance) | B | B | B | B | A | A | A | A |
| Wet rubbing (hydrophilicity) | A | A | A | A | A | A | A | A |

NP: no problem

TABLE 11

| | Example | | | | | | | |
|---|---|---|---|---|---|---|---|---|
| | 25 | 26 | 27 | 28 | 29 | 30 | 31 | 32 |
| Hydrophilicity | A | A | A | A | A | A | A | A |
| Bending resistance | NP | NP | NP | NP | NP | NP | NP | NP |
| Dry rubbing (scratch resistance) | B | B | B | B | B | B | B | B |
| Dry rubbing (hydrophilicity) | A | A | A | A | A | A | A | A |
| Wet rubbing (scratch resistance) | B | B | B | B | B | B | B | B |
| Wet rubbing (hydrophilicity) | A | A | A | A | A | A | A | A |

NP: no problem

TABLE 12

| | Example | | | | | | | |
|---|---|---|---|---|---|---|---|---|
| | 33 | 34 | 35 | 36 | 37 | 38 | 39 | 40 |
| Hydrophilicity | A | A | A | A | A | A | A | A |
| Bending resistance | NP | NP | NP | NP | NP | NP | NP | NP |
| Dry rubbing (scratch resistance) | B | B | B | B | A | A | A | A |
| Dry rubbing (hydrophilicity) | A | A | A | A | A | A | A | A |
| Wet rubbing (scratch resistance) | B | B | B | B | A | A | A | A |
| Wet rubbing (hydrophilicity) | A | A | A | A | A | A | A | A |

NP: no problem

TABLE 13

| | Example | | | | | | | |
|---|---|---|---|---|---|---|---|---|
| | 41 | 42 | 43 | 44 | 45 | 46 | 47 | 48 |
| Hydrophilicity | A | A | A | A | A | A | A | A |
| Bending resistance | NP | NP | NP | NP | NP | NP | NP | NP |
| Dry rubbing (scratch resistance) | B | B | B | B | A | A | A | A |
| Dry rubbing (hydrophilicity) | A | A | A | A | A | A | A | A |
| Wet rubbing (scratch resistance) | B | B | B | B | A | A | A | A |
| Wet rubbing (hydrophilicity) | A | A | A | A | A | A | A | A |

NP: no problem

TABLE 14

| | Comparative Example | | | | | | | |
|---|---|---|---|---|---|---|---|---|
| | 1 | 2 | 3 | 4 | 5 | 6 | 7 | 8 |
| Hydrophilicity | A | A | A | A | C | C | C | C |
| Bending | cracked | cracked | cracked | cracked | NP | NP | NP | NP |
| resistance | | | | | | | | |
| Dry rubbing | B | B | C | C | C | C | C | C |
| (scratch | | | | | | | | |
| resistance) | | | | | | | | |
| Dry rubbing | A | A | C | C | C | C | C | C |
| (hydrophilicity) | | | | | | | | |
| Wet rubbing | C | C | C | C | C | C | C | C |
| (scratch | | | | | | | | |
| resistance) | | | | | | | | |
| Wet rubbing | A | A | C | C | C | C | C | C |
| (hydrophilicity) | | | | | | | | |

NP: no problem

As apparent from Tables 8 to 14, the film produced using the hydrophilic composition of the present invention was good in all of hydrophilicity, dry rubbing, wet rubbing and bending resistance. When Examples 1 to 12, 17 to 20, 25 to 36 and 41 to 44 were compared with Examples 13 to 16, 21 to 24, 37 to 40 and 45 to 48, dry rubbing resistance and wet rubbing resistance were low in Examples 1 to 12, 17 to 20, 25 to 36 and 41 to 44. This is considered to be ascribable to the difference in the W/O/W emulsion. On the other hand, in Examples 13 to 16, 21 to 24, 37 to 40 and 45 to 48, both hydrophilicity and scratch resistance were satisfied and the film quality was also very flexible.

In Comparative Examples 1 and 2, both hydrophilicity and dry rubbing resistance were satisfied, but the wet rubbing resistance was low because of easy swelling and the film quality was very brittle. In Comparative Examples 3 and 4, hydrophilicity was high, but since the binder was too brittle, even when the W/O/W emulsion was added, the performance in terms of both dry rubbing and wet rubbing was low. In Comparative Examples 5 to 8, brittleness was improved by the addition of the W/O/W emulsion, but because of low hydrophilicity of the hydrophilic polymer and absence of a crosslinking group, hydrophilicity and performance in terms of dry rubbing and wet rubbing were low.

### INDUSTRIAL APPLICABILITY

Examples of the field where the hydrophilic member of the present invention can be applied include, as for the usage to which a substrate capable of transmitting visible light is applicable, a mirror such as rearview mirror for vehicles, bathroom mirror, lavatory mirror, dental mirror and road mirror; a lens such as eyeglass lens, contact lens, optical lens, photographic lens, endoscopic lens, illumination lens, semiconductor lens and lens for copier; a prism; a windowpane for buildings or lookout towers; a windowpane for vehicles such as automobile, railway vehicle, airplane, marine vessel, submarine, snow wagon, ropeway gondola and amusement park gondola; a windshield glass for vehicles such as automobile, railway vehicle, airplane, marine vessel, submarine, snow wagon, snowmobile, motorcycle, ropeway gondola and amusement park gondola; a glass for protective goggles, sporting goggles, motorcycle goggles, protective mask shields, sporting mask shields, helmet shields, frozen food display cases, camera finders and displays; a cover glass for measuring instruments such as meter, and image sensors such as CCD and CMOS; and a film for the lamination to the surface of these articles.

Other uses to which the hydrophilic member is applicable include a building material, a building exterior material, a building interior material, a window frame, a windowpane, a heat exchanger fin material for air conditioners, a structural member, an exterior or coat for vehicles, an exterior, dust cover or coat for mechanical devices and articles, an exterior or coat for traffic signs, various indicators, advertising towers, road noise barriers, railroad noise barriers, bridges and guardrails, an interior or coat for tunnels, an insulator, a solar cell cover, a heat collector cover for solar water heaters, a sensor for analyzers, a plastic greenhouse, a cover for vehicle lights, housing equipment, a toilet, a tile, a siding, a bathtub, a washstand, a lighting instrument, a lighting cover, a kitchen utensil, a dish, a dish washer, a dish drier, a sink, a faucet, a cooking range, a kitchen hood, a range hood, a ventilation fan, a stove, a film for the lamination to the surface of these articles, a housing, component, exterior or coat for home electric appliances, a housing, component, exterior or coat for OA equipment products, a film for the lamination to the surface of these articles, a fiber for diapers, filters and the like, and a sealer for various coating materials, functional films and the like. The hydrophilic member has wide applicability.

According to the present invention, a hydrophilic polymer and a W/O/W emulsion are combined, whereby appropriate flexibility can be imparted, swelling can be suppressed and in turn, the dry scratch resistance and wet scratch resistance can be enhanced. Also, even when the coating film is abraded, the W/O/W emulsion is crushed and the hydrophilic compound comes out from the inside, so that the hydrophilicity can be held over a long time.

The entire disclosure of each and every foreign patent application from which the benefit of foreign priority has been claimed in the present application is incorporated herein by reference, as if fully set forth.

What is claimed is:

1. A hydrophilic composition, comprising:
a hydrophilic polymer (A) containing a crosslinking group; and
a W/O/W type emulsion (B).

2. The hydrophilic composition according to claim 1,
wherein the W/O/W type emulsion (B) contains an inner aqueous phase, an outer aqueous phase and a wall material located between the inner aqueous phase and the outer aqueous phase.

3. The hydrophilic composition according to claim 1,
wherein the crosslinking group of the hydrophilic polymer (A) is a hydrolyzable silyl group.

4. The hydrophilic composition according to claim 3,
wherein the hydrophilic polymer (A) has a structure represented by following formula (I): 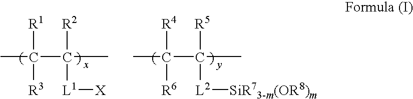
wherein R¹ to R⁸ each independently represents a hydrogen atom or a hydrocarbon group;
L¹ represents a single bond or a polyvalent organic linking group;
L² represents a single bond or a polyvalent organic linking group having at least one structure selected from the group consisting of —CONH—, —NHCONH—, —OCONH—, —SO₂NH— and —SO₃—;
m represents an integer of 1 to 3;
x and y define compositional ratio and each represents a number satisfying x+y=100 in ranges of 0<x<100 and 0<y<100; and
X represents —OH, —ORₐ, —CORₐ, —CO₂Rₑ, —CON(Rₐ)(R_{b}), —N(Rₐ)(R_{b}), —NHCOR_{d}, —NHCO₂Rₐ, —OCON(Rₐ)(R_{b}), —NHCON(Rₐ)(R_{b}), —SO₃Rₑ, —OSO₃R_{c}, —SO₂R_{d}, —NHSO₂R_{d}, —SO₂N(Rₐ)(R_{b}), —N(Rₐ)(R_{b})(R_{c}), —N(Rₐ)(R_{b})(R_{c})(R_{g}), —PO₃(Rₑ)(R_{f}), —OPO₃(R_{c})(R_{f}) or —PO₃(R_{d})(Rₑ) in which Rₐ, R_{b} and R_{c} each independently represents a hydrogen atom or an alkyl group, R_{d} represents an alkyl group, Rₑ and R_{f} each independently represents a hydrogen atom, an alkyl group, an alkali metal, an alkaline earth metal or an onium, and R_{g} represents an alkyl group, a halogen atom, an inorganic anion or an organic anion.

5. The hydrophilic composition according to claim 2,
wherein the wall material contains at least one selected from the group consisting of polyester resin, polyamide resin, acrylic resin, vinyl resin, hydrocarbon resin, epoxy resin, urethane resin, urea resin, acrylic silicon resin and polyamide resin.

6. The hydrophilic composition according to claim 2,
wherein a surface of the wall material is treated with a hydrophilic compound.

7. The hydrophilic composition according to claim 2,
wherein a surface of the wall material has a crosslinking group capable of crosslinking with the hydrophilic polymer (A).

8. The hydrophilic composition according to claim 7,
wherein the crosslinking group of the wall material is a hydrolyzable silyl group.

9. The hydrophilic composition according to claim 1, further comprising:
an initiator or catalyst (C) that accelerates crosslinking of the hydrophilic polymer.

10. A hydrophilic treated member obtained by a method comprising:
applying the hydrophilic composition according to claim 1 to a substrate so as to form an applied hydrophilic composition; and
drying the applied hydrophilic composition to form a film having a thickness of from 10 nm to 100 μm.

11. The hydrophilic treated member according to claim 10,
wherein the hydrophilic composition is applied by a spray coating method, a spin coating method, a dip coating method, a roll coating method, a flow coating method, a bar coating method or a coating method using a sponge.
